(19) United States
(12) Patent Application Publication
(10) Pub. No.: US 2020/0067789 A1
(43) Pub. Date: Feb. 27, 2020

(54) SYSTEMS AND METHODS FOR DISTRIBUTED SYSTEMIC ANTICIPATORY INDUSTRIAL ASSET INTELLIGENCE

(71) Applicant: QiO Technologies Ltd., Hampshire (GB)

(72) Inventors: Bharat Khuti, Huntsville, AL (US); Sasa Jovicic, Parkland, FL (US); Kevin Malik, Scottsdale, AZ (US); Scott Taggart, Woking (GB); Pankaj Wahane, Thane (IN); Satish Patil, Pune (IN); Nauman Khan, London (GB); Vishal Adsool, Pune (IN); Rick Haythornthwaite, London (GB)

(21) Appl. No.: 16/561,940

(22) Filed: Sep. 5, 2019

Related U.S. Application Data
(63) Continuation of application No. 15/631,685, filed on Jun. 23, 2017, now abandoned.
(60) Provisional application No. 62/356,171, filed on Jun. 29, 2016.
(60) Provisional application No. 62/354,540, filed on Jun. 24, 2016.

(51) Int. Cl. H04L 12/24; H04L 12/721; G06N 20/00; G06N 5/04

(52) U.S. Cl. CPC H04L 41/16; H04L 45/70; H04L 67/10; G06N 5/046; H04L 41/22; G06N 20/00

(57) ABSTRACT

The foregoing are among the objects attained by the invention which provides cloud native distributed, hierarchical methods and apparatus for the ingestion of data generated by a fully-instrumented manufacturing or industrial plants. The systems and methods employ an architecture that is capable of collecting and preliminarily processing data at the plant-level for self-learning detection of error (and other) conditions, and forwarding that data for more in depth processing in the cloud. The architecture takes into account the varied data throughput, storage and processing needs at each level of the hierarchy. The distributed and hierarchical system allows for the creation of a dynamic, real-time assessment of the behavior and health of assets and enables visibility and integrity into the design, manufacturing, operations and service of any asset. The use of that capability (referred to herein as PARCS™) allows for Systemic Asset Intelligence within an asset, plant, system and/or an ecosystem.

This application is a continuation of U.S. patent application Ser. No. 15/631,685, filed Jun. 23, 2017, which claims the benefit of filing of commonly-owned, United States Provisional Patent Application Serial Nos. 62/354,540, filed Jun. 24, 2016, and 62/356,171, filed Jun. 29, 2016, the contents of all which are incorporated herein by reference in their entireties.

### BACKGROUND OF THE INVENTION

The invention pertains to digital data and, more particularly, the collection and systemic anticipatory intelligence of extremely large data sets a/k/a “big data” from industrial assets and systems. The invention has application in manufacturing, energy, utilities, aerospace, marine, defense and other enterprises that generate vast sums of asset data. The invention also has application to the collection and anticipatory analysis of asset-related data in other fields such as, by way of non-limiting example, financial services and health care.

With the rise in computing power, growth of digital networks and fall in sensor prices, equipment of all sorts are becoming increasingly instrumented. Nowhere is this trend more obvious, for example, than in industry, where virtually every piece of physical equipment, from the most complex electromechanical devices to the most mundane materials mixing vessels, have hundreds of sensors and supporting diagnostic systems. It is no small feat to provide the distributed infrastructure necessary to carry that information to factory control rooms, where technicians and automated workstations can monitor it to ensure optimum and safe plant operation. The trend in health care and other enterprises has equally been toward instrumentation. This has resulted in the inclusion of sensors and diagnostics in equipment residing everywhere from computed tomography (CT) scanners used in hospitals to color copiers in corporate offices.

Turning our attention again to industrial enterprises, the technologies behind the so-called Industry 4.0 hold promise in allowing that same data to be collected and analyzed at still higher levels in the enterprise. Also, Industry 4.0 holds great promise for industrials to connect design, manufacturing, operations and service—through horizontal and vertical integration with suppliers and customers—to enable digital ecosystems to be created. A narrow view of Industry 4.0, focused purely on IoT (internet of things) as sensory networks connected to interact with external systems and the environment, fails to address business process automation across partner networks driven by the complementary technologies that will fuel Industry 4.0

An object of the invention is to provide improved methods and apparatus for digital industrial data and, more particularly, for example, for the collection and automated analysis of extremely large data generated by industrial assets, health, enterprise and other assets.

A related object of the invention is to provide such methods and apparatus as an integrated suite of predictive self-service applications in health care manufacturing, industrials (such as Power, Oil & Gas, Mining, Chemicals and defense) and other enterprises that generate vast sums of industrial asset data. A further related object is to provide such methods and apparatus as find application in financial industries, e.g., in support of real time physical asset risk assessment, valuation and financing of equipment- and other equipment-intensive businesses.

Still another object of the invention is to provide such methods and apparatus as capitalize on existing Industry 4.0 technologies and other that are yet to overcome their shortcomings.

### SUMMARY OF THE INVENTION

The foregoing are among the objects attained by the invention which provides distributed, hierarchical systems and methods for the ingestion of data generated by a instrumented assets in manufacturing and/or industrial plants, hospitals and other health care facilities and other enterprises. The systems and methods employ an architecture that is capable of (1) collecting and standardizing industrial and other protocols, (2) preliminarily autonomous processing data and analytics, as well as (3) executing predictive diagnostic (and, potentially, remedial) applications, at the plant or facility level for detection of error and other conditions (and, potentially, correcting same), and (4) forwarding those data for more in-depth fleet/enterprise processing in a private or public cloud or a combination—ensuring the architecture is Cloud Neutral (i.e. operate on any cloud provider and cloud instance). Those systems and methods include edge services to process and intelligently identify the nearest, most readily available and/or highest throughput/cost effective cloud services provider to which to transmit data for further analysis or applications. The architecture takes into account the varied data throughput as well as storage and processing needs at each level of the hierarchy.

Related aspects of the invention provide such systems and methods having an architecture as shown in FIG. 1a and described below in connection therewith.

Related aspects of the invention provide such systems and methods, e.g., as described shown in FIG. 1a and described below in connection therewith, that include computing apparatus (edge cloud) local to the plant or other facilities that provide the data ingestion function. Multiple ones of such apparatus can be placed in the plant/facility, in clusters or otherwise. Such apparatus can host analytics, predictive algorithms and applications at the edge to reduce bandwidth, latency and provide plant or other facility level applications and information. The hardware and software components within such an apparatus, according to related aspects of the invention, are shown in FIG. 1b, detailed the underlying software architecture to rapidly ingest, learn and process data design, deploy predictive models and integrate insights into new applications or existing IT or Industrial applications.

Further related aspects of the invention provide such systems and methods, e.g., as described above, in which the aforesaid computing apparatus include control nodes, a command unit and network, security services, encryption and/or threat protection. They can further include a physical firewall and cloud operating system. See FIG. 1c for an Edge Cloud physical hardware architecture for systems according to aspects of the invention.

Still further related aspects of the invention provide such systems and methods, e.g., as described above, in which the aforesaid computing apparatus translate protocols, aggregate, filter, standardize, learn, store and forward, data received from plant sensors, devices, in the plant or other facility.

Yet still further related aspects of the invention provide such systems and methods, e.g., as described above, in which the aforesaid computing apparatus execute microservices (FIG. 1d, details the PaaS architecture via Kubernetes to implement Microservices in systems according to aspects of the invention) to facilitate the delivery of the aforesaid analytics and application functionality. Those microservices can be registered, managed and/or scaled through the use of Cloud PaaS (platform as a service) methodologies. FIG. 1e provides an example of Microservices implementation for asset and user authorization in systems according to aspects of the invention.

Still yet further related aspects of the invention provide such systems and methods, e.g., as described above, in which software executing in the aforesaid computing apparatus also runs in the main cloud (public or private) platform to which those (local) computing apparatus are coupled for communication. The public and/or private cloud instance of that software samples data in sub seconds time intervals and edge cloud services can handle data generated in frequencies of MHz or GHz; and has ‘store and forward’ capabilities of data to the public and/or private cloud on an as needed basis.

Further related aspects of the invention provide such systems and methods, e.g., as described above, including an self-learning optimization model (referred to herein as PARCS™) as described, e.g., in FIG. 13a, that attempts to identify and predict the likelihood of any potential reason for failure of an Asset based on a five dimensional model called PARCS™. FIG. 13b details the system processing components of the predictive optimization engine in systems according to aspects of the invention.

Further aspects of the invention provide a hierarchical system for data ingestion that includes one or more computing apparatus coupled for communication via a first network to one or more local data sources. The computing apparatuses preliminarily process data from the data sources, including executing predictive diagnostics to detect error and other conditions, and forward one or more of those data over a second network for processing by a selected remote computing platform, which performs in-depth processing on the forwarded data.

Related aspects of the invention provide systems, e.g., as described above, wherein the first network includes a private network and the second network includes a public network, and wherein the local computing apparatus select, as the computing platform, one that is nearest, most readily available and/or has the best cost performance.

Further related aspects of the invention provide systems, e.g., as described above, wherein one or more of the local computing apparatus process data from the data sources sampled down to a first time interval (e.g., milliseconds—MHz or GHz), and wherein the remote computing platform processes data sampled down to a second time interval. The remote computing platform aggregates data from multiple local computing apparatus, to aggregate, consolidate and provide enterprise view of system and ecosystem performance across multiple facilities and Assets.

Still further related aspects of the invention provide systems, e.g., as described above, wherein the data sources comprise instrumented manufacturing, industrial, health care or vehicular or other equipment. The latter can include, by way of example, equipment on autonomous vehicles to determine real time PARCS™ score per vehicle. In the case of manufacturing and/or industrial equipment, aspects of the invention provide systems in which such equipment is coupled to one or more of the computing apparatus via digital data processing apparatus that can include, for example, programmable logic controllers.

Still further related aspects of the invention provide systems, e.g., as described above, wherein one or more of the local computing apparatus execute the same software applications for purposes of preliminarily processing data from the data sources as the remote computing platform executes for purposes of in-depth processing that data.

Yet still further related aspects of the invention provide systems, e.g., as described above, wherein one or more of the computing apparatus aggregate, filter and/or standardize data for forwarding to the remote computing platform. In other related aspects, the invention provides such systems wherein one or more of the computing apparatus forward data for more in-depth processing by the selected remote computing platform via any of (i) a shared folder or (ii) posting time series datapoints to that platform via a representational state transfer (REST) applications program interface. In such systems, the remote computing platform can perform in-depth processing on the time series datapoints to predict outcomes and identify insights that can be integrated in incumbent IT (Information Technology) and OT (Operational Technology) systems.

The invention provides, in other aspects, a hierarchical system for data ingestion that includes a computing platform executing an engine (“cloud edge engine”) providing a plurality of software services to effect processing on data. One or more computing apparatus that are local to data sources but remote from the computing platform execute services of the cloud edge engine to (i) collect, process and aggregate data from sensors associated with the data sources, (ii) forward data from those data sources for processing by the computing platform and (iii) execute in-memory advanced data analytics. The edge computing apparatuses process data from the data sources sampled down to millisecond time intervals (MHz or GHz), while the remote computing platform processes forwarded data. According to aspects of the invention, services of the cloud edge engine executing on the computing apparatus support continuity of operations of the instrumented equipment even in the absence of connectivity between those the edge computing apparatus and the computing platform.

Related aspects of the invention provide systems, e.g., as described above, wherein the services of the cloud edge engine executing on the computing apparatus are registered, managed and scaled through the use of platform as a service (PaaS) functionality.

Other aspects of the invention provide systems, e.g., as described above, wherein the computing apparatuses forward data to the computing platform using a push protocol. Related aspects of the invention provide such systems wherein the computing apparatuses forward data to the platform by making that data available in a common area for access via polling.

Still other aspects of the invention provide systems, e.g., as described above, wherein the cloud edge engine comprises an applications program interface (API) that exposes a configuration service to configure any of a type of data source, a protocol used for connection, security information required to connect to that data source, and metadata that is used to understand data from the data source. The cloud edge engine can, according to further aspects of the invention, comprise a connection endpoint to connect a data source as per the configuration service, wherein the endpoint is a logical abstraction of integration interfaces for the cloud edge engine. Such an endpoint can support, according to further aspects of the invention, connecting any of (i) relational and other storage systems, (ii) social data sources, and (ii) physical equipment generating data.

Yet still other related aspects of the invention provide systems, e.g., as described above, wherein the cloud edge engine includes a messaging system to support ingestion of streams of data in MHz or GHz speeds directly from industrial assets, process in-memory predictive analytics and forward data to remote private or public cloud systems.

Still other related aspects provide systems, e.g., as described above, wherein the cloud edge engine comprises an edge gateway service comprising an endpoint to which sensors connect to create a network. The Edge Cloud can have multiple Gateways connected to the Edge Cloud, and data ingestion and lightweight applications can be installed on Gateways to reduce latency and improve processing.

Still yet other related aspects of the invention provide systems, e.g., as described above, in which the cloud edge engine comprises an edge data routing service that time-stamps and routes data collected from the data sources to a persistent data store. The edge data routing service can, according to other related aspects of the invention, analyze data for a possibility of generating insights based on self-learning algorithms.

Further aspects of the invention provide systemic asset intelligence systems constructed and operated in the manner of the systems described above that additionally include an self-learning optimization engine executing on one or more of the computing apparatus and computing platform to identify and predict failure of one or more data sources that comprise smart devices. That self learning optimization engine (as shown, by way of example, for systems according to some practices of the invention, in FIGS. 13a and 13b) can, according to related aspects of the invention, execute a model that performs a critical device assessment step for purposes of any of identifying critical device function, identifying potential failure modes, identifying potential failure effects, identifying potential failure causes and evaluating current maintenance actions or other actions as needed to rectify the predictive insight.

In further related aspects of the invention, the self learning optimization engine of systems, e.g., as described above, executes a model that performs a device performance measurement step to calculate any of asset performance, availability, asset reliability, asset capacity and asset serviceability. In still further related aspects of the invention, that model can perform a real time PARCS™ score to generate asset health indices and/or to predict asset maintenance and optimization.

Other aspects of the invention provide methods for data ingestion and for systemic asset intelligence paralleling operation of the systems described above.

The foregoing and other aspects of the invention are evident in the drawings and in the detailed description that follows.

### BRIEF DESCRIPTION OF THE DRAWINGS

A more complete understanding of the invention may be attained by reference to the drawings, in which:

FIG. 1a depicts a distributed system architecture according to one practice of the invention;

FIG. 1b depicts the NAUTLIAN software platform architecture in a system according to one practice of the invention;

FIG. 1c depicts the physical hardware architecture of Cloud in a Box in a system according to one practice of the invention;

FIG. 1d depicts Paas Architecture implementation with Kubernetes in a system according to one practice of the invention;

FIG. 1e depicts an example of micro service implementation in a system according to one practice of the invention;

FIG. 1f depicts multi-tenant infrastructure in a system according to one practice of the invention;

FIG. 2 depicts an architecture for a multi-tenant billing engine of the type used in a system according to the invention;

FIG. 3 depicts an architecture of a system according to the invention for use with a single plant;

FIG. 4 depicts use of a system according to the invention to manage multiple plants;

FIG. 5 depicts a UML diagram for an edge cloud implementation according to one practice of the invention;

FIGS. 6-7 depicts a flow diagram for an edge cloud ingestion process according to one practice of the invention;

FIG. 8 depicts processing of data by a system according to one practice of the invention;

FIG. 9 depicts a high-level architecture of an edge cloud engine according to one practice of the invention;

FIG. 10 depicts an example of expression evaluation in a system according to one practice of the invention;

FIG. 11 depicts an example of utilization of Cassandra for storage in a system according to the invention;

FIG. 12 depicts a failure rate over time of an asset;

FIG. 13a depicts an optimization framework model used in a system according to the invention;

FIG. 13b depicts the system flow of the PARCS™ engine in a system according to one practice of the invention;

FIG. 14 depicts the failure cycle of a device of the type that can be monitored and fingerprinted in a system according to the invention;

FIG. 15 depicts an interface between a sensor network and an edge cloud machine in a system according to the invention;

FIG. 16 depicts edge cloud data access in a system according to the invention;

FIG. 17 depicts a smart device according to the invention and a system in which it is embodied;

FIG. 18a is a mind map to facilitate understanding the Asset Discovery Service in a system according to one practice of the invention;

FIG. 18b depicts Asset Discovery Service user interface in a system according to one practice of the invention;

FIG. 19 depicts a comparison of empirical physics approach to data science approach via PARCS™ in a system according to one practice of the invention;

FIG. 20 depicts an example of PARCS™ to create real time efficiency scores in a system according to one practice of the invention;

FIG. 21 illustrates utilization of predictive application portfolio according to the invention by industry “verticals”;

FIG. 22 depicts a sustainability index as provided in systems according to the invention; and

FIG. 23 depicts an architecture for systems according to the invention for autonomous (and other) vehicles; and

FIG. 24 depicts the application of the invention to financial services for risk management in a system according to one practice of the invention

### DETAILED DESCRIPTION OF ILLUSTRATED EMBODIMENT

For the sake of simplicity and without the loss of generality, the discussion below focuses largely on practices of the invention in connection with predictive enterprise-level plant and industrial monitoring and control. The invention has application, as well, in health care, financial services and other enterprises that benefit from the collection and systemic anticipatory analysis of large data sets generated by hospitals, office buildings and other facilities, as will be evident to those skilled in the art from the discussion below and elsewhere herein. In these regards, it will be appreciated that whereas industrial “plants” are often referenced in regard to the embodiments discussed below, in other embodiments, the other embodiments, the term “facility” may apply.

### Architecture

Industry 4.0 holds great promise, yet, is hugely overhyped. A narrow view of Industry 4.0 as sensory networks connected to interact with external systems and the environment, fails to address the complementary technologies that will enable Industry 4.0.

Systems according to the invention embrace those technologies. They feature architectures to meet the strategic Industry 4.0 needs of enterprises into the future; functionality that ingests data from different industrial protocols and systems at the edge cloud, with each data connection defined as microservices to facilitate the delivery of predictive analytics and application functionality. Such cloud systems, moreover, can support multi-tenancy by client and asset, allowing data for multiple customers (e.g., enterprises) to be transmitted to, stored on, and/or processed within a single, cloud-based data processing system without risk of data commingling or risk to data security. Multi-tenancy further facilitates the delivery of Industrial SaaS (software as a service) application functionality by taking advantage of economies of scale, pay on usage, lower cost and re-use.

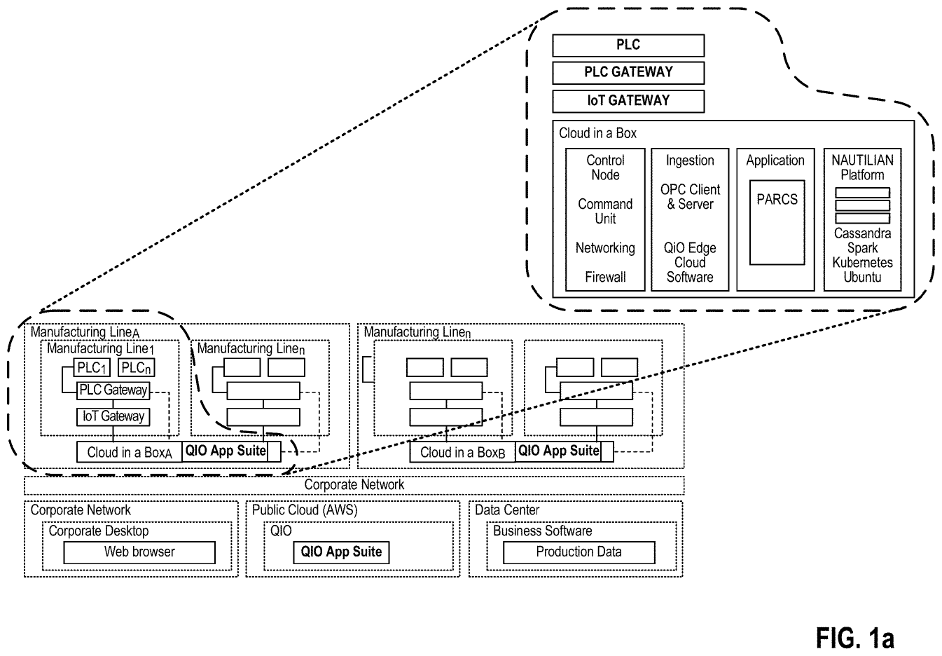

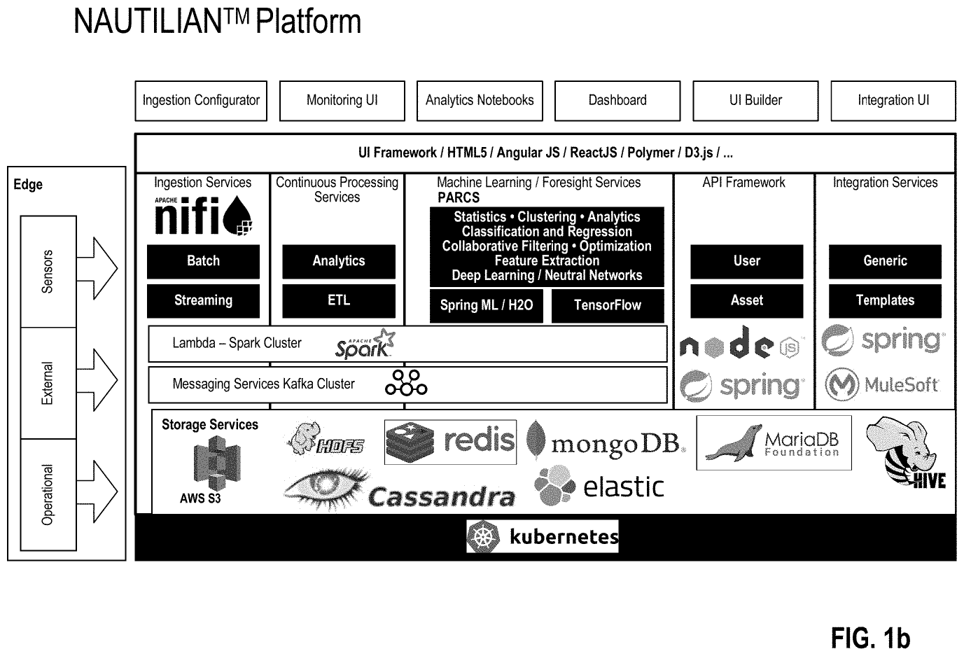

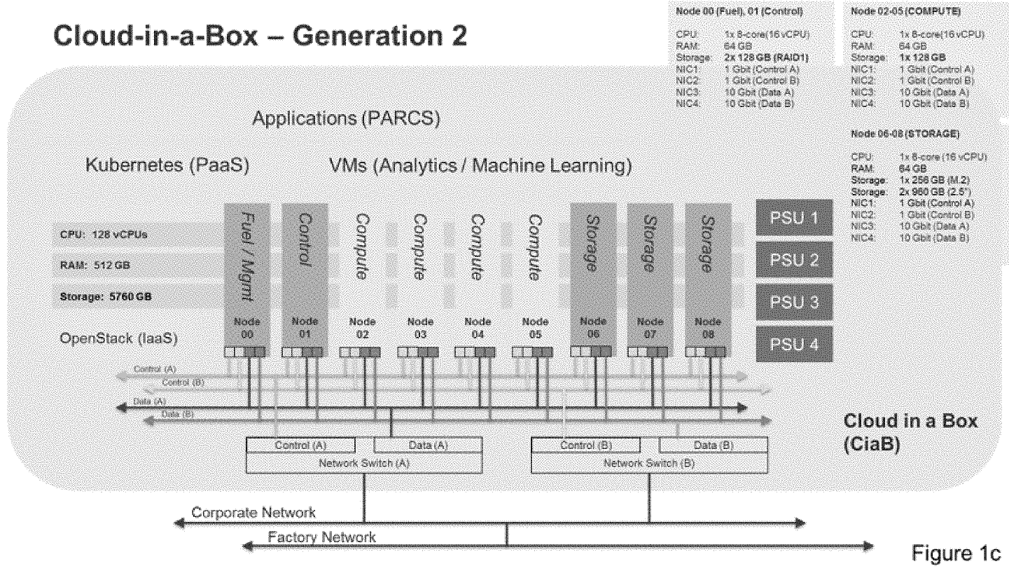

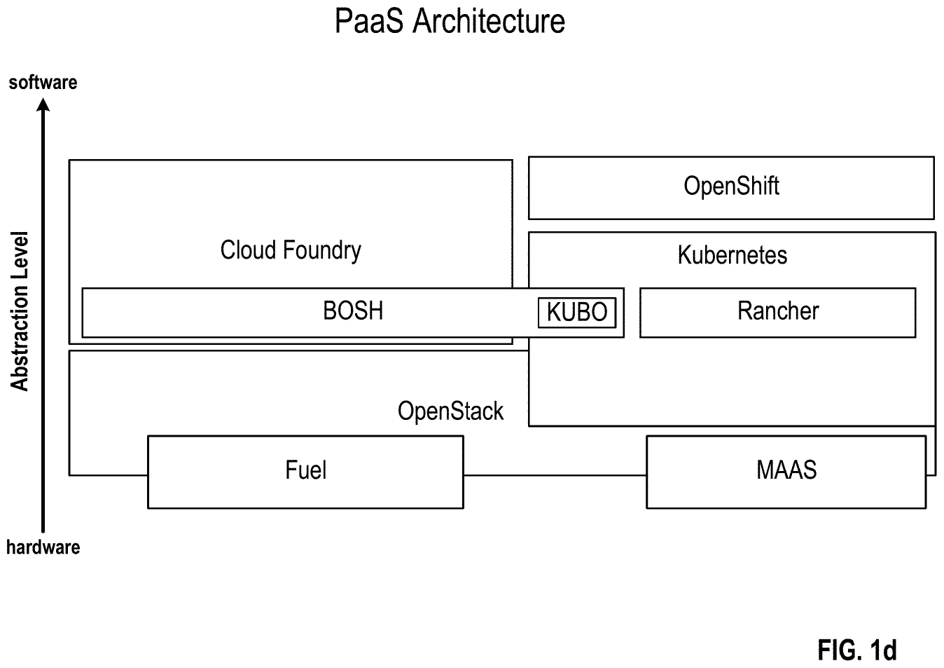

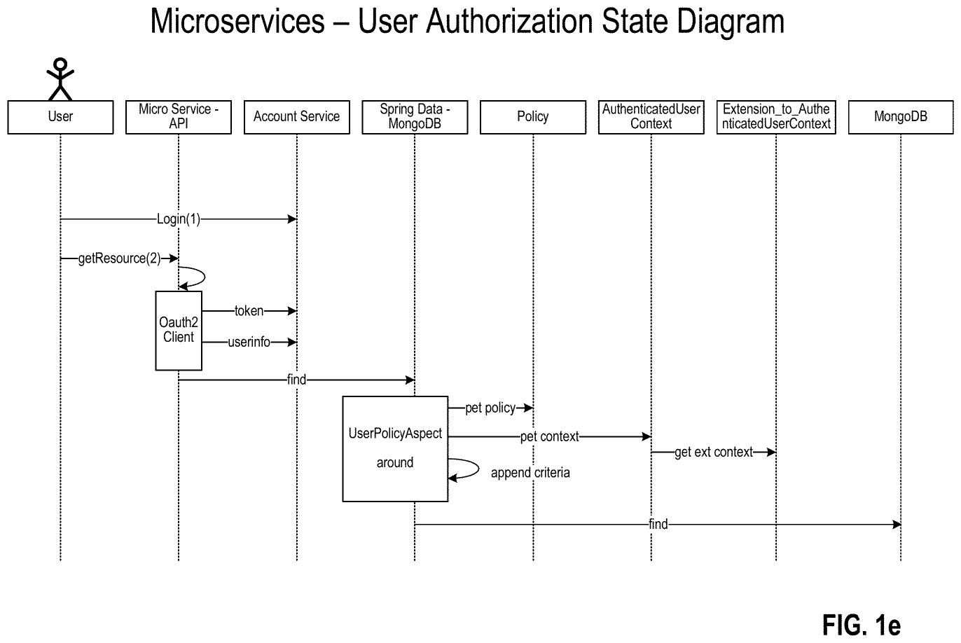

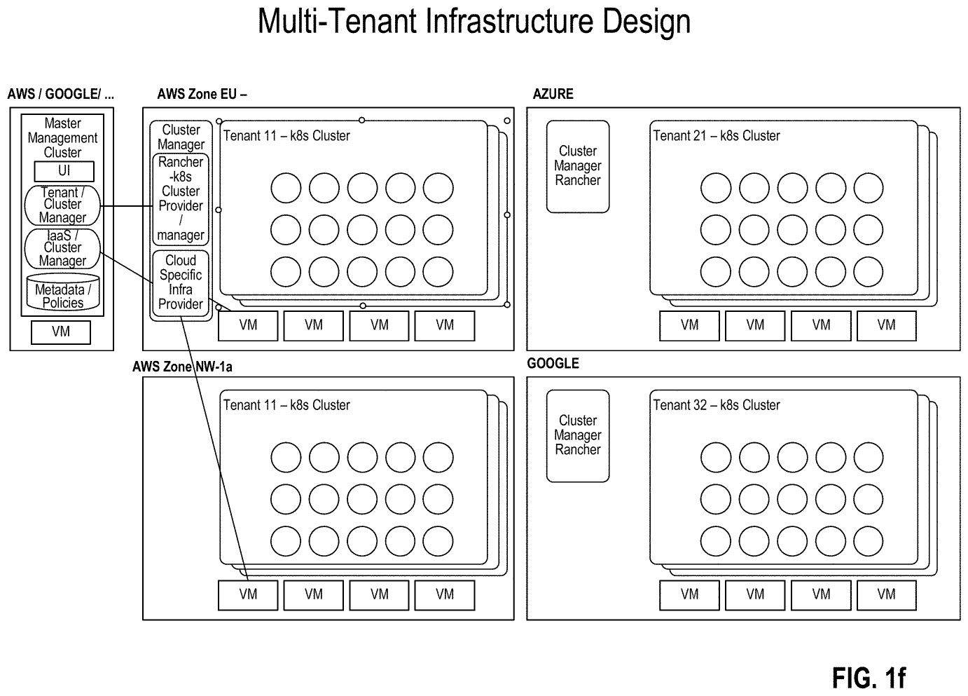

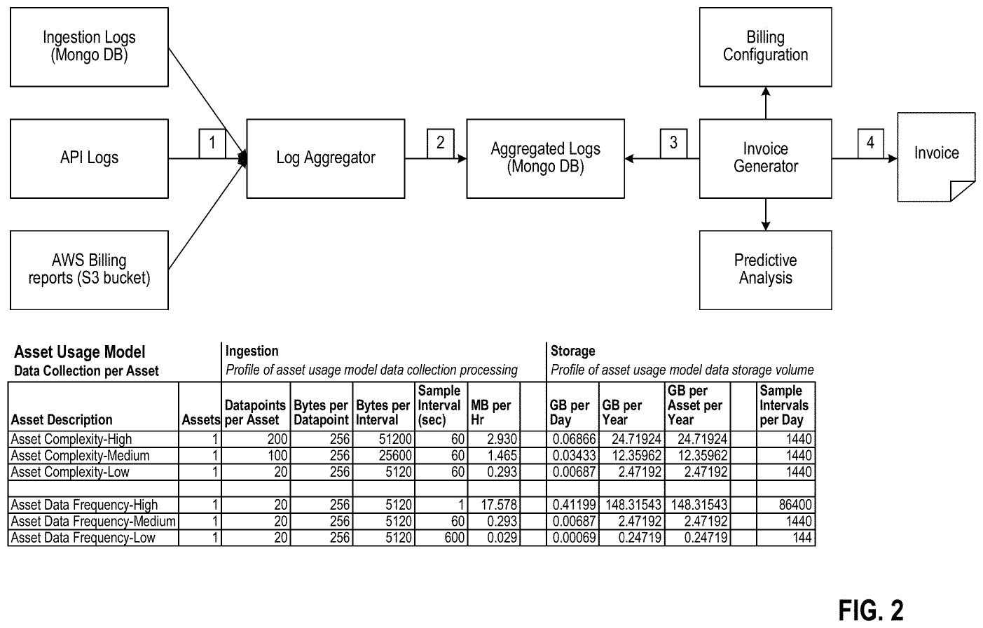

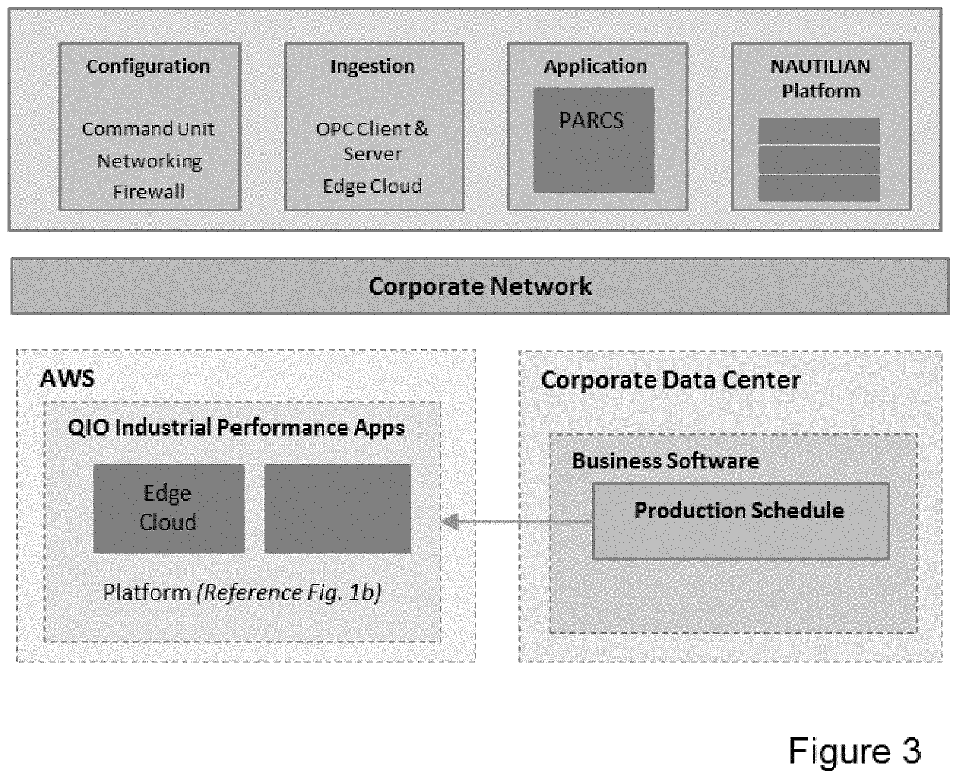

One such system, suitable for supporting industrial and enterprise data from a manufacturing, industrial or other enterprise, is shown in FIG. 1a, where the enterprise is referred to under the term “Manufacturing Site, Industrial Plant or Manufacturing Line” for simplicity. In the text that follows, systems according to the invention, as well as those in which the invention is embodied, are sometimes referred to as “QiO NAUTLIAN software platform.”

The items identified (explicitly or implicitly) in FIG. 1a as industrial assets or machinery connected to PLCs (programmable logic controllers) are facility (i.e. plant), machinery, sensors, or other functionality of the type conventional in the art or otherwise (notwithstanding that term typically refers to only a single such type of machinery, to wit, a programmable logic controller). Those “PLCs” generate data in a manner conventional in the art for such equipment and/or sensors, which data may be of varying formats and/or structure. PLC systems may connect to SCADA, DCS or MES systems. Edge Cloud services can also connect to these systems to source data.

The items identified (explicitly or implicitly) in FIG. 1a as PLC Gateways represent digital data processing apparatus or function of the type conventional in the art or otherwise for collecting data from the machinery, sensors, or other functionality labeled as PLCs. Connectivity to edge cloud services via Open Platform Communications—Unified Architecture (OPC UA) card(s) allows remote connectivity to PLC systems and data collection. An example of additional apparatus of this type is provided in the section entitled “Smart Device Architecture,” below. The PLC Gateways can be implemented in proprietary vendor specific computing apparatus of the type available in the marketplace (e.g., from vendors such as Rockwell, Alan Bradley, Siemens etc.) as adapted in accord with the teachings hereof.

The items identified (explicitly or implicitly) in FIG. 1a as IOT Gateways collect data either directly from Assets, PLCs and/or from PLC Gateways. The IoT Gateways can be implemented in computing apparatus of the type available in the marketplace (e.g., from Dell, H P and Cisco, among others) as adapted in accord with the teachings hereof.

The items identified (explicitly or implicitly) in FIG. 1a as Cloud-in-a-box (aka Edge Cloud) provide the data ingestion function described below, i.e., the edge cloud software services.

These may be implemented in micro-servers or other computing apparatus of the type available in the marketplace as adapted in accord with the teachings hereof—see FIG. 1c, by way of example, for custom cloud-in-a-box hardware. In the illustrated embodiment, these are horizontally scalable, in clusters and can be managed remotely for maintenance (including, for example, hot deploys with automated scripts). The cloud in box also includes a platform (referred to below as the “QiO NAUTILIAN™ Platform,” “NAUTILIAN™” or the like, see FIG. 1b) that can host advanced analytics, PARCS™ engine and applications at the edge to reduce bandwidth and latency as well as provide plant, manufacturing site or other facility level applications and information.

The items identified (explicitly or implicitly) in FIG. 1a of the Cloud in a Box include Control nodes, in turn, including a command unit and network, security services such as IPS/IDS, encryption and threat protection as illustrated. These can further include a physical firewall, cloud operating system (such as, by way of non-limiting example, Openstack, Container technology such as Kubernetes or Docker and other cloud technologies). The Control nodes may be implemented in microservers or other computing apparatus available in the marketplace as adapted in accord with the teachings hereof.

The items identified (explicitly or implicitly) in FIG. 1a as Ingestion (and referred to elsewhere herein as the “Edge Cloud”) translate protocols, aggregates, filters, standardizes, store, learn and forward, and integrates with OPC UA to enable common connectivity to multiple systems and protocols. The Ingestion functionality may be implemented in both the Cloud in a Box microserver and/or in a public/private cloud of the type available in the marketplace as adapted in accord with the teachings hereof. Synchronization of edge cloud services, edge data, edge applications and edge analytics is effected via the QiO NAUTILIAN™ Platform hosted in public/private instances, on any cloud provider.

The items identified (explicitly or implicitly) in FIG. 1a as Application are local manufacturing or industrial performance applications with low latency (e.g., <10 ms) to provide business continuity on private factory networks with no or minimal network availability to corporate network or securely to the Internet.

FIG. 1b depicts the NAUTLIAN software platform architecture in a system according to one practice of the invention. The items identified (explicitly or implicitly) in FIG. 1b as NAUTLIAN™ Platform provide the additional cloud-based services described below. These may be implemented cloud-in-a-box microservers or public and/or private cloud infrastructures available in the marketplace as adapted in accord with the teachings hereof. In the illustrated embodiment, these execute open source software, as illustrated and as adapted in accord with the teachings hereof, are horizontally scalable and included ability to cluster for redundancy, including edge security services. Cloud in Box services integrate, sync and are managed by NAUTLIAN™ Platform to ingest data, distribute interfaces (API's), application logic and analytics to the edge services hosted on the Cloud in a Box.

### Micro-Services

Micro-services provide the ability to distribute data logic, API's, algorithms and application features between edge cloud services and public/private cloud hosted applications and analytics Micro-services are registered, managed and scaled through the use of a PaaS (Platform as a Service) components within the NAUTILIAN™ platform. In systems according to the invention that employ it, the micro-services architecture provides the following advantages over the traditional service oriented architecture:

| | TRADITIONAL SOA | MICROSERVICES |
|---|---|---|
| MESSAGING TYPE | Smart, but | Dumb, fast |
| | dependency-laden | messaging (as with |
| | ESB | Apache Kafka) |
| PROGRAMMING | Imperative model | Reactive actor |
| STYLE | | programming model |
| | | that echoes agent- |
| | | based systems |
| LINES OF CODE | Hundreds or | 100 or fewer lines of |
| PER SERVICE | thousands of lines of | code |
| | code | |
| STATE | Stateful | Stateless |
| MESSAGING TYPE | Synchronous: wait to | Asynchronous: |
| | connect | publish and |
| | | subscribe |
| DATABASES | Large relational | NoSQL or micro-SQL |
| | databases | databases blended |
| | | with conventional |
| | | databases |
| CODE TYPE | Procedural | Functional |

### Micro-Services Benefits

The benefits of the micro services architecture for Industry 4.0 approach include:

| BENEFIT | IMPLEMENTATION |
|---|---|
| Resilient/Flexible - failure in one | A modular graceful degradation design |
| service does not impact other | in the Industrial SaaS applications allows |
| services. In traditional monolithic | for individual services to fail or degrade |
| architectures - errors in one | without significantly impacting customer |
| service/module can severely | experience and service |
| impact other modules/functionality. | |
| High scalability - demanding services | Edge Cloud, individual API units, |
| can be rapidly deployed in multiple | individual function blocks and individual |
| servers to enhance performance and | feature blocks can all be automatically or |
| keep away from other services so that | manually scaled independently of one- |
| they don't impact other | another with no interruption in service |
| services. Impossible to achieve | |
| with single, large monolithic service. | |
| Easy to enhance/deploy - less inter- | All above units can be deployed with |
| dependency and easy to change and test | zero interruption to service |
| Easy to understand since micro-services | Independence of function and feature |
| represent a small piece of functionality | blocks allows for simpler separation |
| | and understanding of deployments |
| Freedom to choose technology stacks - | The use of NAUTILIAN ™ platform |
| allows selection technology that is best | with the supporting build-packs allows |
| suited for a particular functionality or | for fully flexible choice of languages |
| service | and supporting stacks/frameworks for |
| | each feature |

FIG. 1c depicts the physical hardware architecture of Cloud in a Box in a system according to one practice of the invention. FIG. 1d depicts Paas Architecture implementation with Kubernetes in a system according to one practice of the invention. FIG. 1e depicts an example of micro service implementation in a system according to one practice of the invention. Figure if depicts multi-tenant infrastructure in a system according to one practice of the invention;

### Architecture for a Single Manufacturing Site

FIG. 3 depicts an architecture of a system according to the invention for a single plant. With reference to labeled elements in that drawing:

### Edge Cloud

The same version of the NAUTILIAN™ software running in the main cloud platform (e.g., Amazon's AWS service or Microsoft Azure) also executes local to the plant in a microserver-based Cloud in a Box (or in other computing apparatus local to the plant). The cloud instance of Edge Cloud samples data in sub-seconds time intervals and can handle data generated in frequencies of MHz or GHz. The local Cloud in a Box instance samples in milliseconds, and has ‘store and forward’ capabilities if connectivity is lost to the main cloud instance, hereinafter occasionally referred to as “Edge Cloud” or the like. Edge Cloud Services in AWS or MS Azure public or private cloud aggregates, filters and standardizes data from local Edge Cloud instances, e.g., at different locations in plant and/or in different plants. Edge cloud services hosted on the cloud-in-a-box can ingest data at Giga hertz speeds (streaming) from industrial assets such as a turbine in test mode, and provide local analytics to identify and predict potential performance issues.

Edge Cloud services provide for standardization, aggregation, learning through the PARCS™ engine and filtering of data from industrial devices. There exists the ability to store and forward data from the Edge Cloud to public or private cloud instances based on availability of network connectivity, bandwidth, latency and application/analytical needs. Equally the ability to deploy analytical models and applications developed in the main cloud (public or private) to the cloud-in-a-box (bi-directional) is also possible.

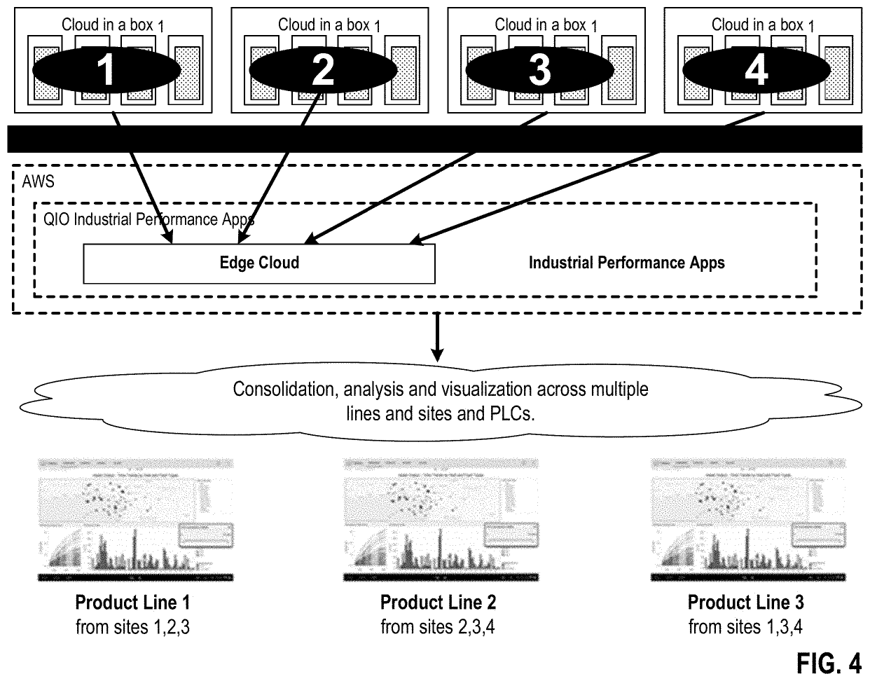

Public or private cloud (main) hosted Edge Cloud software services can manage thousands or more of industrial assets, plant and manufacturing site instances—standardization, aggregation, learning and filtering of site data, as suggested in FIG. 4.

### SaaS Industrial Performance Applications and Analytics

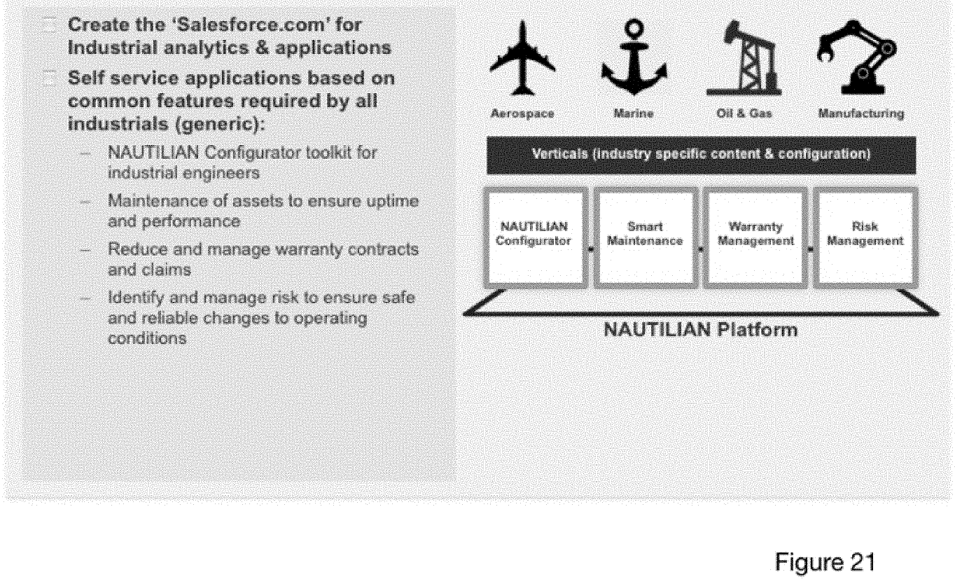

As above, same version of the SaaS (software as a service) Industrial Performance Applications and analytics running on the public or private cloud as local Cloud in a Box instance and augmented with data from SAP ERP or other business systems or social media networks to supplement production information. Site level industrial performance applications for real time analytics (milliseconds) and aggregated site manufacturing line analysis (standalone or connected modes). FIG. 21 illustrates the SaaS based portfolio of applications that can be deployed at the edge or on the main public cloud.

### NAUTLIAN™ Platform

FIG. 1b provides a summary of all the software components for the NAUTILIAN™ platform that can be deployed on a Public or private cloud version is similar to the edge version except for integration of software (such as MuleSoft or otherwise) which will support integration with SAP and other business/external software or social media networks.

### Industrial and Enterprise Protocol Conversions and Data Transfer

Industrial protocol translator from proprietary industrial equipment and PLC manufacturers to OPC (Open Protocol Communications) via the installation of OPC UA client and server software hosted both in the Cloud in a Box and the public/private cloud configurations provides the ability to connect to proprietary vendor specific protocols, ingest data and apply standards and learning machine (via PARCS™) to proprietary data formats. The OPC UA client is configured with the Edge Cloud services to determine the frequency of data collection from industrial assets and PLC systems and provide edge to main cloud connectivity.

### Architecture for Multiple Manufacturing Sites Site—Enterprise Fleet View

FIG. 4 depicts the enterprise fleet view of a system according to the invention executing a multiple plants (or “sites”—terms which are used interchangeably in this document). With reference to labeled elements in that drawing:

### Cloud in a Box

Each cloud-a-box instance running OPC UA and edge cloud services connects back to the public and or private NAUTILIAN™ in the same way and all data is keyed by Site Identifier (tenant)

### SaaS Industrial Performance Applications and Analytics

Provides consolidated view across all industrial plants and manufacturing sites, including integration with business systems such as SAP, Oracle ERP or IBM Maximo. Can be configured to group sites by tenant, asset, asset type, region, product lines, and/or manufacturing lines.

SaaS Industrial Performance applications and analytics are shown in FIG. 21.

### Data Consolidation

The use of open source software technologies (predominately Apache Kafka, Apache Spark and Cassandra) to consolidate data from multiple sites—either in real-time or on a batch basis.

### Secure Multi-Tenant Architecture

To aggregate data from multiple sites within one database schema for sites, assets and customers through the use of Tenant-ID's per asset allows for segmentation and isolation of tenant data, ability to add Blockchain keys to tenant data to uniquely identify source data and location. Information on tenant and asset utilization is integrated in the billing engine service (see FIG. 2).

### Edge Cloud Architecture

The illustrated system (a/k/a the QiO NAUTILIAN Platform) uses the Edge Cloud Engine for data ingestion. Data ingestion is the process of obtaining, importing, learning and processing data for later use or storage in a database. This process often involves connectivity, loading and application of standards and aggregation rules. Data is then presented via API's to application services. In built learning engine (PARCS™) automates the time to map data and apply intelligence to the underlying data structures.

Edge Cloud Engine data ingestion methodology systematically to validate the individual files; transform them into required data models; analyze the models against rules; serve the analysis to applications requesting it.

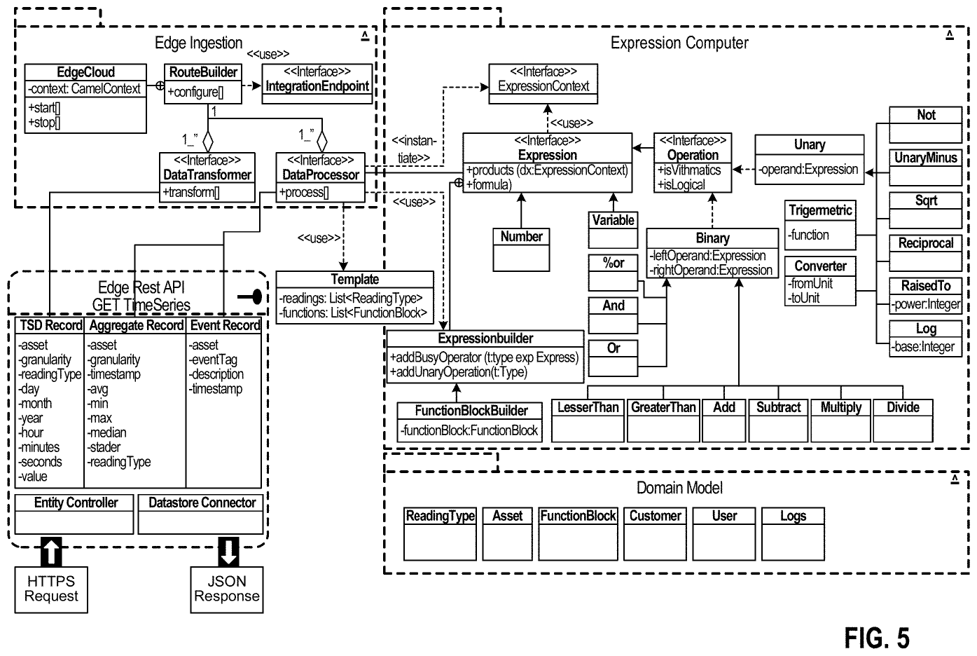

A UML diagram for an Edge Cloud implementation according to one practice of the invention is shown in FIG. 5.

### Real Time Ingestion

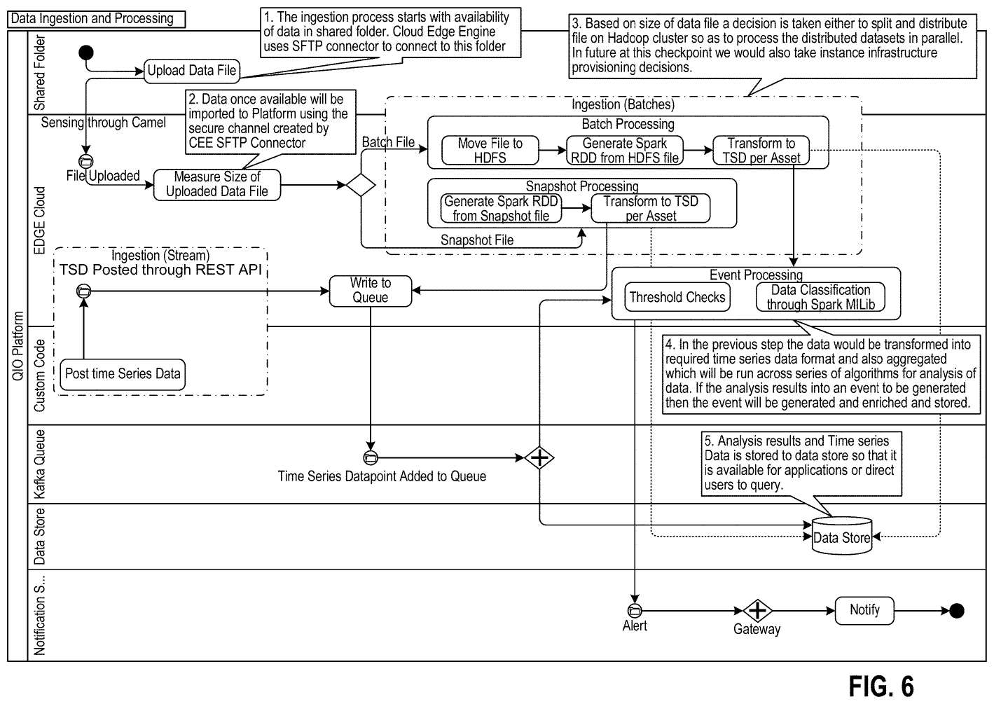

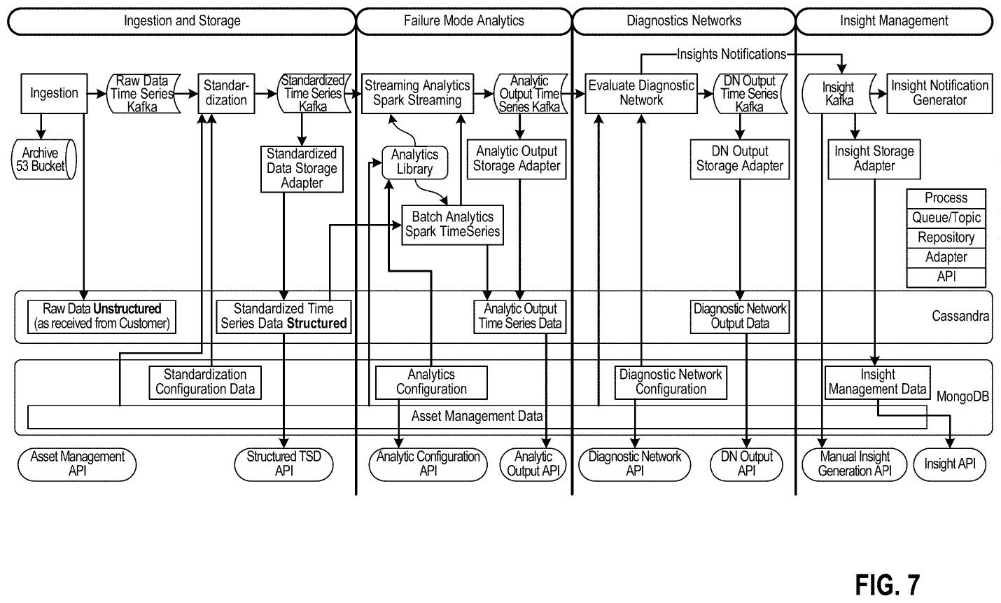

FIG. 6 and FIG. 7 are flow diagrams depicting the Edge Cloud ingestion process.

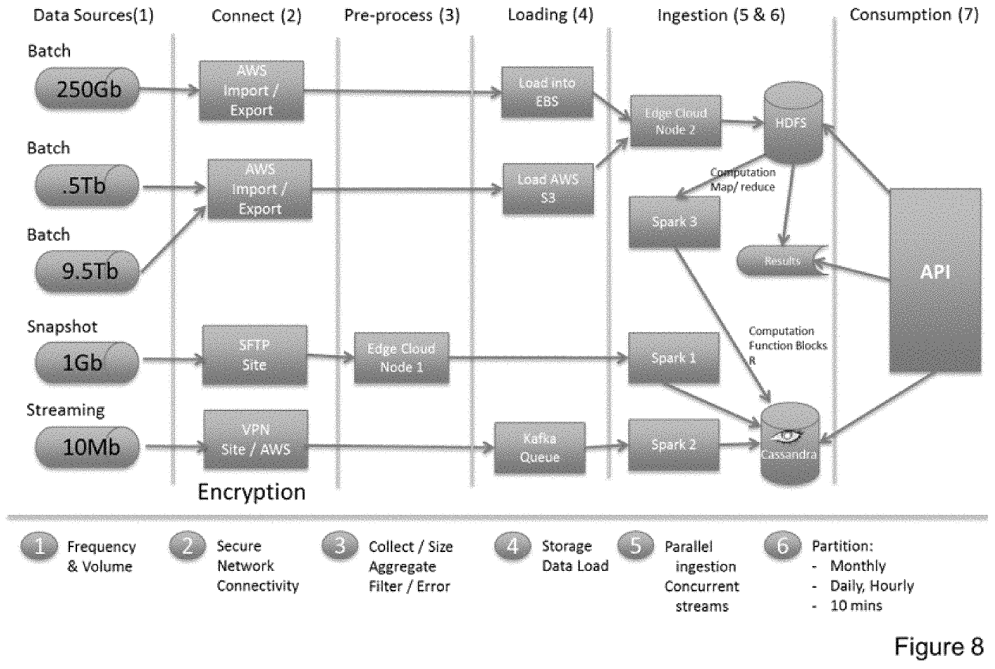

FIG. 8 illustrates a real time streaming volume of data that can be processed by even a small system according to the invention. In such a system, an effective data ingestion methodology begins by validating the individual data records, files, then prioritizing the sources for optimum processing, and finally validating the results. When numerous data sources exist in diverse formats (the sources may number in the hundreds and the formats in the dozens), maintaining reasonable speed and efficiency can become a major challenge.

Building blocks for such a system include open source and other big data technologies, all adapted in accord with the teachings hereof. For example, data was loaded onto secure ftp folders within the public or Private cloud. Edge cloud services according to the invention were written to pre-process the data, sequence Apache Spark jobs to load the data into Big Data stores such as Cassandra and Hadoop (HDFS).

More generally, Edge Cloud Services are the ingestion endpoint of QiO's NAUTILIAN™ Platform. In some embodiments, uses HDFS and or Cassandra to store data in distributed fashion; Apache Spark for high speed data transformation and analysis; Cassandra for efficient storage and retrieval of Time Series Data. Cassandra also allows data storage for complex lookup structures; and/or Apache Kafka is used for defining routing rules and weaves all technologies together to allow interoperability, synchronicity and order.

Billing Engine

FIG. 2 depicts a real-time billing engine of the type used in systems according to the invention. The real time billing engine captures ingestion per tenant and asset to actually monitor the consumption data, analytics and applications and create a cost of services and infrastructure consumed to bill the client.

The billing engine serves as the general purpose metrics calculator for the entire platform with principal responsibility of providing feedback to the NAUTILIAN platform architecture for optimising resource utilisation and also provide a framework for charging the tenants based on usage of platform services. For such an optimisation it computes and reports the overall utilisation of resources consumed, referred to as Asset Use Model. The integration of the Billing Engine with Syniverse (a leading mobile roaming telecom services provider) provides the ability to leverage Syniverse's software services to generate usage based pricing (akin to data plans on a cell phone) per client, per asset on a global basis. The above billing service and integration with Syniverse can occur at the edge or on a remote cloud.

Referring to FIG. 2, components of the billing engine include:

Log Aggregator: This component reads ingestion, API and cloud billing logs and converts them into statistics that can be used readily to generate the Utilisation Report.

Invoice Generator: This component reads a billing configuration (which is very simple that says total cost of processing+storing per KB data is $xxx—broken into several sections—for a specific subscription) and creates an invoice based on attached excel template below:

Tenant Tenant 1
Sub Tenant Sub Tenant 1
Month Apr-16
Data

| | | | | | |
|---|---|---|---|---|---|
| | | Billing | Last | | |
| Particulars | Description | Month | Readings | Accrual | Units |

Ingestion

| | | | | |
|---|---|---|---|---|
| Total Data Acquired | 10 | 17 | 27 | GB |
| Expanded Data Size | 35 | 59.5 | 94.5 | GB |
| Ignored Records | 4 | 6.8 | 10.8 | Million |
| Ingested Records | 100 | 170 | 270 | Million |

Analytics

| | | | | |
|---|---|---|---|---|
| Total Data Processed | X | X | X | GB |
| Total Data Generated | X | X | X | GB |
| Total Records | X | X | X | Million |
| Generated | | | | |

DN

| | | | | |
|---|---|---|---|---|
| Total Data Processed | X | X | X | GB |
| Total Data Generated | X | X | X | GB |
| Total Records | X | X | X | 100K |
| Generated | | | | |

Insights

| | | | | |
|---|---|---|---|---|
| Total Data Processed | X | X | X | GB |
| Total Data Generated | X | X | X | GB |
| Total Records | X | X | X | K |
| Generated | | | | |

| Ingestion | | Analytics | | DN | | Insights | |
|---|---|---|---|---|---|---|---|
| Processing | Storage | Processing | Storage | Processing | Storage | Processing | Storage |

Costs Incurred

| | | | | | | | |
|---|---|---|---|---|---|---|---|
| X | X | X | X | X | X | X | X |

Costs Levied

| | | | | | | | |
|---|---|---|---|---|---|---|---|
| X | X | X | X | X | X | X | X |

Rate Card

| Item | Billing Unit | Rate |
|---|---|---|
| Processing | 1 GB | $ x |
| Storage | 1 GB | $ x |

FIG. 2 illustrates an example of how Asset Use Model is calculated based on the table above.

Predictive Analysis (PARCS™) engine: This component is responsible for forecasting the subsequent month usage by a particular tenant and asset to ensure capacity, service and quality are maintain proactively. In the table, the estimation is same as the current month's utilisation, although, that is not necessarily the case in most circumstances.

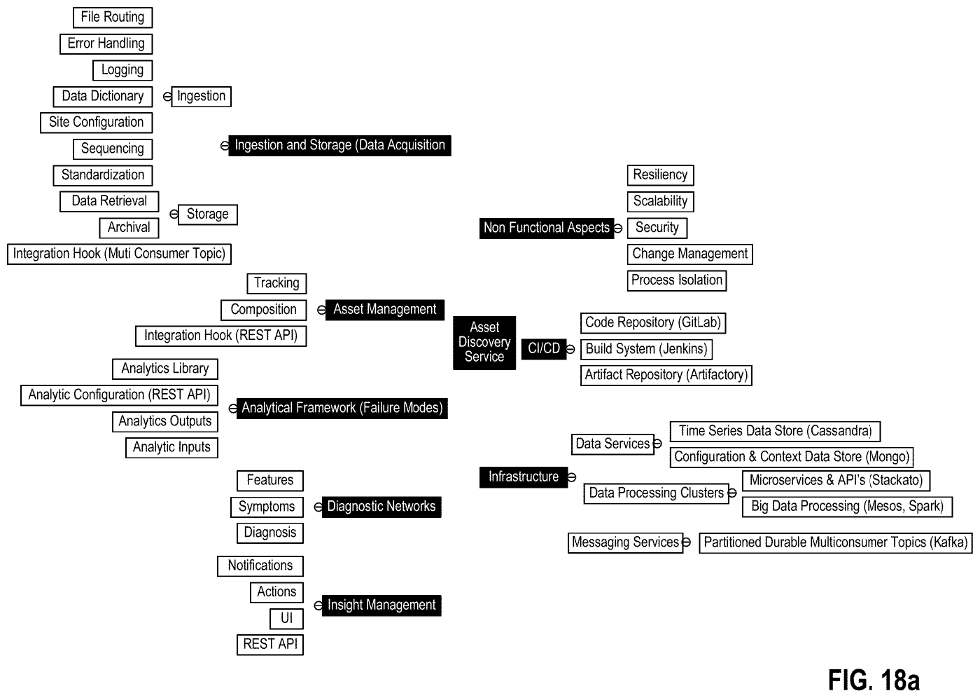

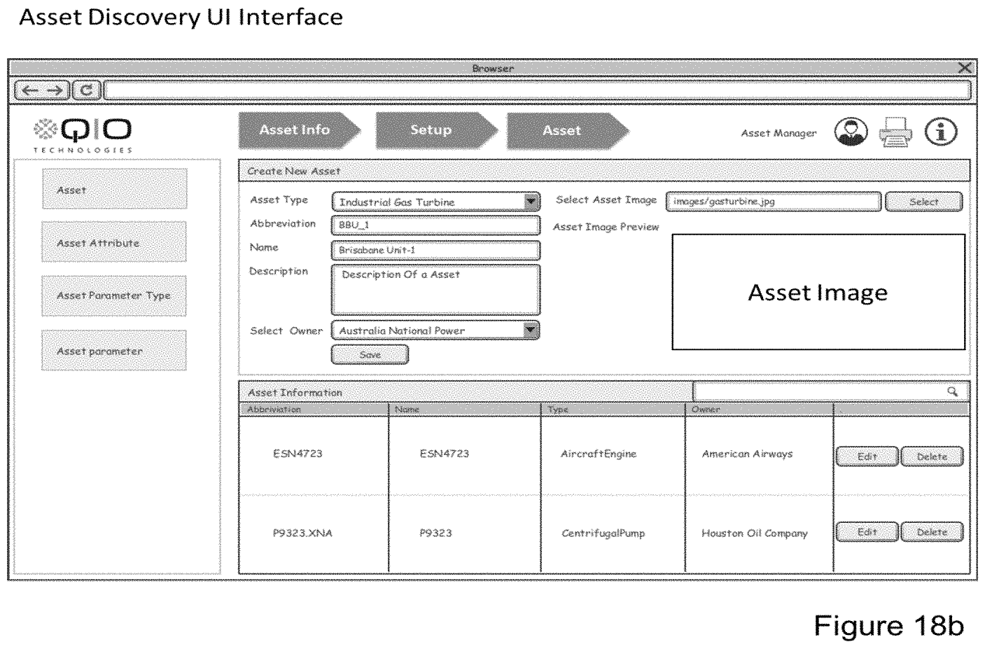

The cost incurring components are placed to the right of the following mind map whereas the chargeable components are placed on the left in mind-map of FIG. 18a.

Representative source code for an embodiment of the billing engine follows:

```
BillingEngine.java
import java.time.Instant;
import java.util.List;
/**
* Billing engine reads and analyzes
*/
public class BillingEngine {
  /**
  * Operators
  */
  private IngestionLogReader ingestionLogReader;
  private ApiUsageLogReader apiUsageLogReader;
  private InfrastructureUsageLogReader infrastructureUsageLogReader;
  private LogAggregator logAggregator;
  private BillingPlanManager billingPlanManager;
  private BillGenerator billGenerator;
  private BillingEnginePredictiveAnalysis
  billingEnginePredictiveAnalysis;
  private ReportConsolidator reportConsolidator;
  private MonthlyUsageReportAndEstimationRepository
monthlyUsageReportAndEstimationRepository;
  private Notifier notifier;
}
```

### Edge Cloud Services Architecture

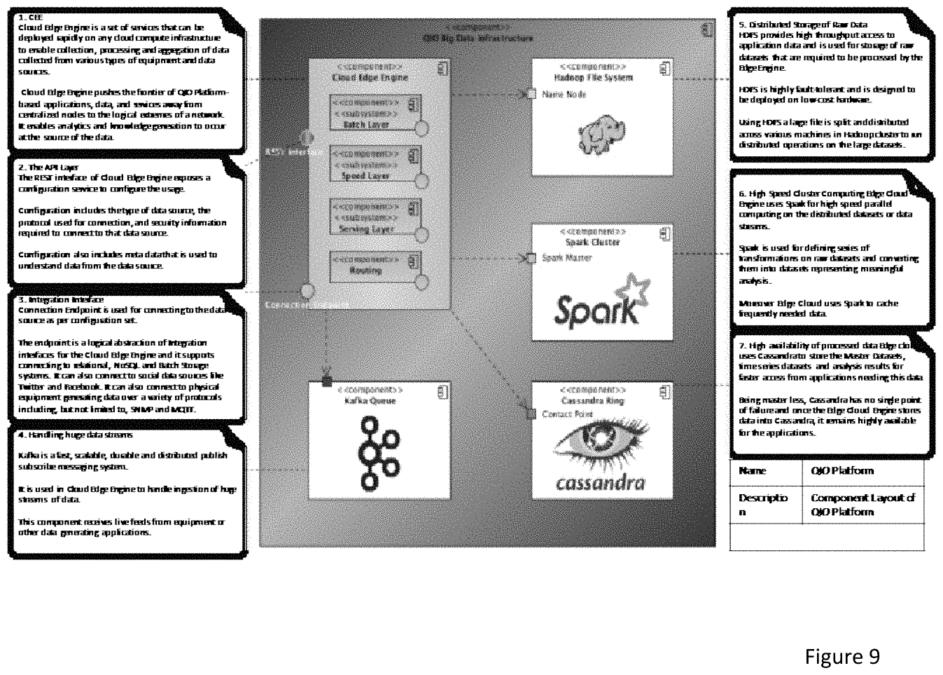

FIG. 9 diagram describes a high-level architecture for an Edge Cloud Services in a system according to the invention. An explanation of elements in that drawing follows:

### 1. Cloud Edge Engine (CEE)

Cloud Edge Engine is a set of services that can be deployed rapidly on any cloud compute infrastructure to enable collection, processing, learning and aggregation of data collected from various types of equipment and data sources. Cloud Edge Engine pushes the frontier of QiO Platform-based applications, data, analytics and services away from centralized nodes to the logical extremes of a network. The CEE enables analytics and knowledge generation to occur at the source of the data.

### 2. The API Layer

The REST interface of Cloud Edge Engine exposes a configuration service to configure the usage. Configuration includes the type of data source, the protocol used for connection, and security information required to connect to that data source. Configuration also includes metadata that is used to understand data from the data source.

### 3. Integration Interface

Connection Endpoint is used for connecting to the data source as per configuration set. The endpoint is a logical abstraction of Integration interfaces for the Cloud Edge Engine and it supports connecting to relational, NoSQL and Batch Storage systems. It can also connect to social data sources like Twitter and Facebook. It can also connect to physical equipment generating data over a variety of protocols including, but not limited to, SNMP and MQTT.

### 4. Handling Huge Data Streams

Apache Kafka is a fast, scalable, durable and distributed publish subscribe messaging system. It is used in Cloud Edge Engine to handle ingestion of huge streams of data. This component receives live feeds from equipment or other data generating applications.

### 5. Distributed Storage of Raw Data

Cassandra and/or HDFS provides high throughput access to application data and are used for storage of raw datasets that are required to be processed by the Edge Engine. Cassandra is highly fault-tolerant and designed to be deployed on low-cost hardware. Using Cassandra a large file is split and distributed across various machines in Cassandra cluster to run distributed operations on the large datasets. Synchronization of Cassandra data nodes at the edge and with public/private cloud nodes guarantees no data loss.

### 6. High Speed Cluster Computing

Edge Cloud Engine uses Apache Spark for high speed parallel computing on the distributed datasets or data streams—enabling the implementation of the LAMBDA architecture (in memory and batch data processing and analytics). Apache Spark is used for defining series of transformations on raw datasets and converting them into datasets representing meaningful analysis. Moreover Edge Cloud uses Apache Spark to cache frequently needed data.

### 7. High Availability of Processed Data

Edge cloud uses Cassandra to store the Master Datasets, time series datasets and analysis results for faster access from applications needing this data. Being master less, Cassandra has no single point of failure and once the Edge Cloud Engine stores data into Cassandra, it remains highly available for the applications.

Interfacing Edge Cloud Engine with Other Services

Discussed below are techniques for interfacing the Edge Cloud Engine with other services.

### Apache Kafka

Apache Kafka is used for defining routing rules and weaves all technologies together to allow interoperability, synchronicity and order.

### Example Using Kafka

During the data standardization phase of the ingestion process, each raw data record is published to the Kafka Topic “INGESTION_RAW_DATA” with the following format:
tenant_id,asset_id,parameter_id,tag,time,original_value,file_name,archive_name,value

The raw data record is then mapped and transformed into a standardized record.

A JSON message is then formed with the foregoing plus missing parameters and send it to a “Batch Streaming” process step, after all the raw data lines for all parameters of an asset for a specific timestamp have been processed and standardized. This is a pivoted standardized message.

It is possible that the asset data points for a specific timestamp are spread across two or more .dat files within a customer file—a .zip file. This process step ensures that the data from all the files is obtained before forming the pivoted standardized message for the asset/timestamp combination Batch Streaming

The Batch Streaming process step publishes all pivoted standardized messages to a single Kafka Topic called INGESTION_PIVOTED_DATA as Keyed Messages, where the Key is the asset ID string.

The Storage microservice as well as the Analytics service are consumers of that Kafka topic.

When it is done with all the data from the file, it logs step status and completion date under the file log via the Ingestion Logs service—status “Data ingested to Kafka”.

### Pivoted Standardized Messages

Pivoted Standardized Messages can include the following fields

| Field | Description |
|---|---|
| asset | Asset ID |
| data | An object whose fields contain the parameter values. |
| | Each field name is an Asset Type. |
| missingData | An array of Asset Type Parameter IDs for each parameter |
| | value that is missing data for this time point. This field |
| | must never be null. When there are no missing parameter |
| | values, the value of this field should be the empty array [ ] |
| time | The data point time in ISO 8601 format; with milliseconds; |
| | GMT time zone (must have Z appended to the end) |

### Example Apache Spark Transformation

```
//1. Read File
JavaRDD<String> data =
sc.textFile(resourceBundle.getString(FILE_NAME));
//2. Get Asset
String asset = data.take(1).get(0);
//3. Extract Time Series Data
JavaRDD<String> actualData = data.filter(line ->
line.contains(DELIMERTER));
//4. Strip header
String header = actualData.take(1).get(0);
//5. Filter Erroneous Records
JavaRDD<String> validated = timeSeriesLines.filter(line ->
validate(line));
//6. Transform
JavaRDD<TimeSeriesData> tsdFlatMap =
transformTotimeSeries(validated);
//7. Save
javaFunctions(tsdFlatMap).writerBuilder(KEYSPACE),
    TSD_TABLE,mapToRow(TimeSeriesData.class))
    .saveToCassandra( );
//Transformation
JavaRDD<TimeSeriesData> tsdFlatMap = validated.flatMap(line
-> {
            List<TimeSeriesData> rows = new ArrayList<>( );
            String[ ] tokens = line.split(DELIMERTER);
            for (int i = 6; i < tokens.length; i++) {
                TimeSeriesData timeSeriesData = new
TimeSeriesData( );
                timeSeriesData.setAsset(asset);
timeSeriesData.setReadingtype(readingTypeMap.get(headers[i] ));
timeSeriesData.setValue(Double.parseDouble(tokens[i]));
                timeSeriesData.setYear(toInt(tokens[2]));
                timeSeriesData.setMonth(toInt(tokens[1]));
                timeSeriesData.setDay(toInt(tokens[0]));
                timeSeriesData.setHour(toInt(tokens[3]));
                timeSeriesData.setMinute(toInt(tokens[4]));
                timeSeriesData.setSecs(toInt(tokens[5]));
                timeSeriesData.setGranularity(granularity);
                rows.add(timeSeriesData);
}
return rows;
```

### Example Expression Evaluation

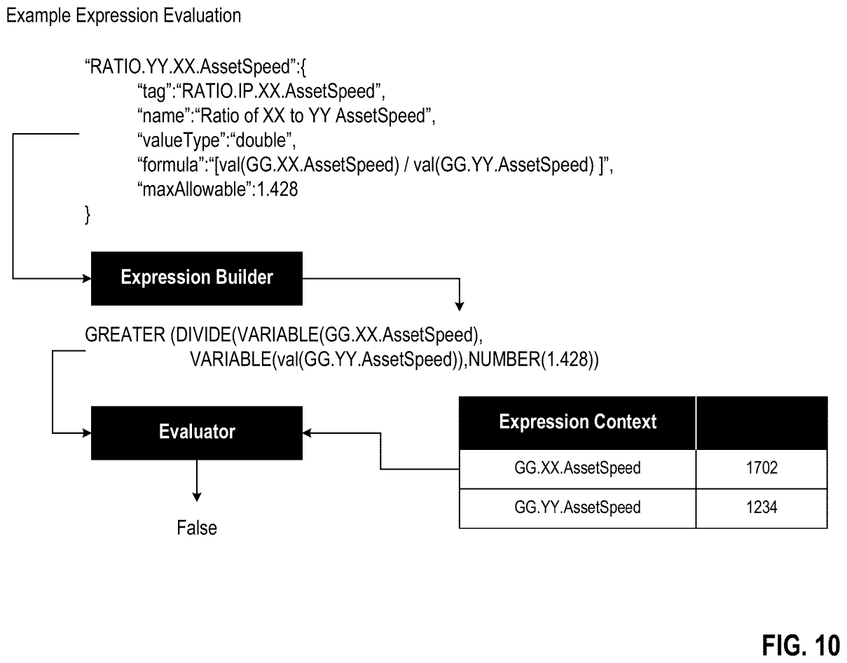

FIG. 10 depicts an example of expression evaluation in a system according to the invention.

### Example Cassandra Storage

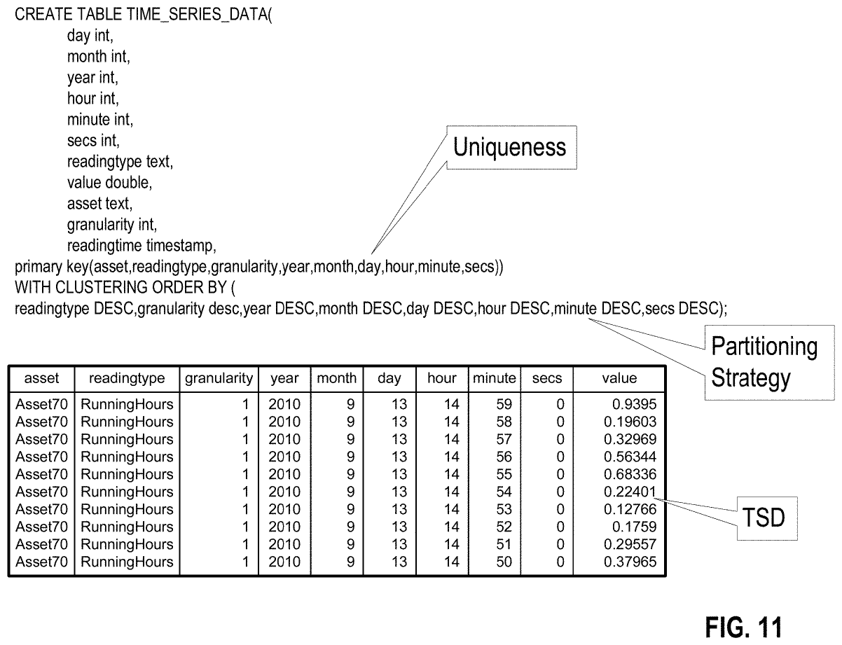

FIG. 11 depicts an example of utilization of Cassandra for storage in a system according to the invention.

### Edge Cloud Machine

The edge cloud machine is set of services that can be deployed on any cloud compute infrastructure to enable collection, processing and aggregation of data collected from various types of sensors. The sensor data can be actively pushed using RESTFul service/AMQP (Advanced Message Queueing Protocol)/MQTT (MQ Telemetry Transport protocol) to the edge cloud machine. In scenarios where active push is not practical the services can be configured to poll sensor data using SNMP/MODBUS protocols. The collected data is saved to a common access Cassandra data store.

Edge cloud machine primarily consists of three interdependent services viz.,
1. Edge IoT Gateway service.
2. Edge Data Routing service.
3. Edge Data Access API.

### Edge Gateway Service

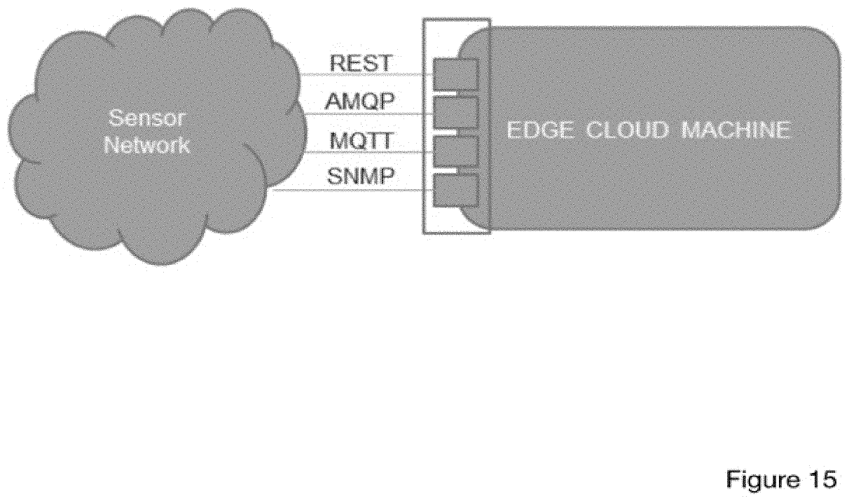

Referring to FIG. 15, the Edge IoT Gateway Service is machine endpoint where the individual sensors installed on Assets or independent (air pollution sensor) connects to the edge cloud to collect data. The endpoint support communication can be over web based (REST), messaging middleware based (AMQP & MQTT or Apache Kafka) queues and widely supported device communication protocols based (SNMP & MODBUS, BacNet, OPC) technologies. Or via OPC UA where the protocol needs to be converted before data ingestion can occur.

To support active data push using Apache Kafka, AMQP or MQTT or REST interface, Apache ActiveMQ is used. It the most popular and powerful open source messaging and Integration Patterns server. Apache ActiveMQ was chosen for implementing the data push considering the requirement of supporting lightweight clients as the sensor data adaptors would be.

The Edge Gateway Services exposes a queue with name “SensorDataQueue”. For supporting AMQP a broker needs to be configured as
activemqbroken(tcp://localhost:61616,network:static:tcp://{remotehost}:61616)?persis tent=false&useJmx=true

For enabling communication over MQTT following configuration is needed in the broker configuration file

<transportConnectors>
<transportConnector name=“mqtt” uri=“mqtt://{remotehost}:1883”/>
</transportConnectors>

For communicating over REST simply use the http POST method like

curl -XPOST -d “body=message”
http://user:password@remotehost:8161/api/
message?destination=queue://SensorDataQueue
{remotehost} = IP Address Of Edge Cloud machine

To enable data polling the Edge Gateway Service can be configured using a configuration message. This message is sent to the Edge Cloud Machine from the Data Access API.

### Edge Data Routing Service

Edge Data Routing service routes the data collected by the data gateway service to a persistent datastore and timestamps it by tenant and asset. The service also tests the possibility of generating event based on preconfigured rules or learnt rules from the PARCS™ engine. If the rule is satisfied the event is generated. This event is further enriched with the information available in rule configuration and time series data available in datastore.

The datastore is implemented using a Cassandra cluster. Cassandra is chosen for its features such as high availability, high scalability and high performance.

For routing Apache Camel is used in this example, but Apache Kafka can also be used. Apache Camel is used to define routing and mediation rules. Leveraging Java based route definitions to route messages internally in the Edge Cloud Machine. These routing rules enable the Edge Cloud Machine functional and operative. The rules dictate when to collect data, where to collect data from, how this data is transformed, aggregated processed and finally stored.

### Edge Data Access API

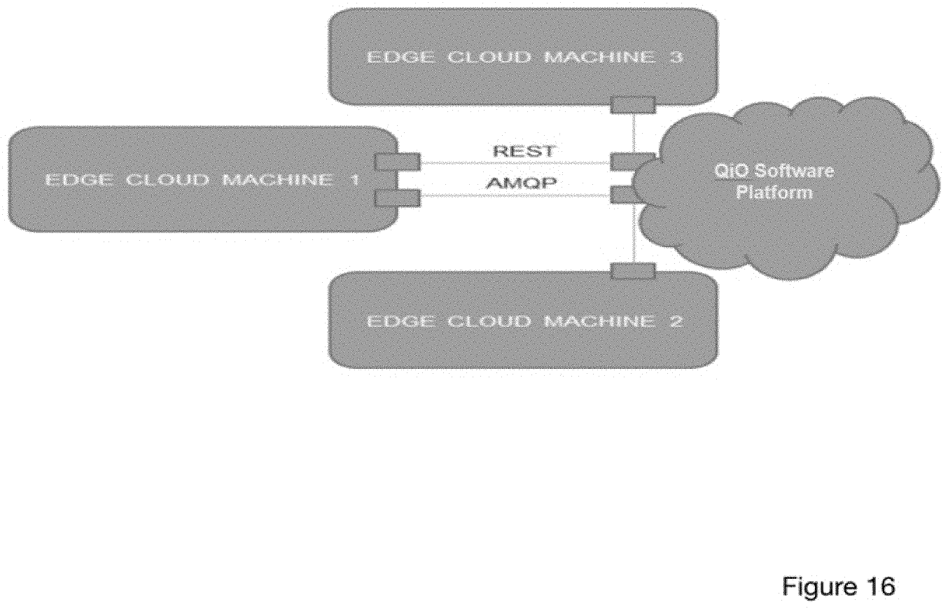

Referring to FIG. 16, the Edge Data Access API is a REST based web interface to Access data about the Edge Cloud machine instance.
1. This data includes the number of active communication endpoints (sensors) it's connected to.
2. The collected sensor data.
3. For receiving configuration message an ActiveMQ queue “ConfigurationQueue” which is exposed for configuring the IoT network controlled by Edge Cloud machine instance
   a. For connecting to Cassandra data store
   b. For active data push the configuration consist of security rules that a sensor data adaptor should satisfy in order to communicate with Edge IoT Gateway Service
   c. For Data polling the configuration message should contain following information about sensor from where data is to be polled
      i. IP Address
      ii. Remote Access Port
      iii. Protocol (SNMP/MODBUS)
      iv. Polling Interval
      v. Sensor Identity (Device Fingerprint/Edge Service Generated Key)

### Systemic Asset Intelligence (SAI)

Systemic Asset Intelligence' across products, product systems and ecosystem. In other words, the ability to seamlessly connect, integrate, secure and drive business outcomes in real time using both human generated (ERP, SCM, CRM, Social Networks etc.) and machine generated data (engines, turbines, compressors etc.). Creating outcomes that cut across horizontal and vertical value chains as well as time horizons (past, present and future). Developing cloud-native, data science-driven, collaborative applications that enable the improvement of safety, optimization of operations and inventories, the guaranteeing of customer service times, and create dynamic pricing models based on product usage patterns.

Described below the systemic asset intelligent model framework based on the automated collection and processing of data in a system according to the invention. The sources of information, proprietary or not, are accessible through connected assets and systems. The processing of this information is done through cloud-based ‘Big Data’ approaches and data science services. The SAI model framework tracks different variables of assets related to performance, availability, reliability, capacity and serviceability (PARCS™)—attributes any industrial asset will either generate or create within a product system. These variables correlate with each other and can predict the health and behavior of an Asset. Based on the prognostic information, a predictive model can be constructed to decide assets optimal performance, maintenance and warranty management cycles and performance. The model outputs can be integrated into application services to enable devices to achieve near-zero downtime.

### Why a Systemic Anticipatory Intelligence (SAI) Model?

System components suffer wear with usage and age as a deterioration process, which causes low reliability, poor performance and—potentially—huge losses to their owners, especially if they are part of large and complex industrial systems. Therefore, risk assessment, maintenance and warranty management are important factors in keeping devices in good operation, both to decrease failure rates and increase performance.

Asset manufacturers often face the problem of being responsible for provision of products with service level agreements. Failure eradication is then a problem for the manufacturer—not a trivial task if the product or service is being provided as part of a large system with complex interactions. The common protocol to deal with Asset breakdown is to investigate notifications from the customer and give recommendations to carry out typical and easy checks. If the fault is not rectified then onsite diagnosis and fixing of devices is carried out by maintenance experts. This asset repair supply chain process is typically reactive, slow, tedious and costly. The most important aspect is cost associated with device down-time. Failure-based maintenance, scheduled maintenance and preventive maintenance models are positive and efficient but how to decide any maintenance interval is crucial task where these traditional models are not effective.

The optimal performance of any depends on several dimensions such as Performance, Availability, Reliability, Capacity and Serviceability aka PARCS™—which are highly correlated. Individual and system asset health and behavior are governed by these dimensions. Traditional models and approaches are not capable of measuring and correlating these dimensions accurately and usually ignore them—due to the cost and infrastructure required to calculate all the permutations—with the use cloud technologies and big data technologies, these limitations are now removed.

Much to the contrary, an systemic asset intelligence model attempts to learn in advance—through connected assets, systems and ecosystems and cloud-based information systems—the prognosis for assets, predicting the likelihood of faults and preventing them through collaborative applications. The prevention of asset failure can dramatically reduce the serving cost of the repair, improve safety and increase operational performance from reduced down time.

The SAI model relies on its ability to collect all relevant information about connected asset, system, sub systems, ecosystem and then process and analyze that information, giving any recommendations/alerts/anomalies in real time. This ability to process the massive amount of asset data (Big Data) in real time using data science tools—and delivering customer feedback in real time—is innovative and game-changing. The formulation of the SAI model framework is likely to be expressed mathematically and statistically to comprehend different objectives and constraints. The SAI model is predictive, self-learning, agile and more cost-effective than traditional alternatives based on legacy software architectures such as Microsoft SQL or Oracle databases.

What can be Achieved with an SAI Model?

The aim of System Anticipatory Intelligence (SAI) is optimal performance whilst ensuring zero-downtime. This means the model attempts to predict the likelihood of any type of industrial asset downtime or asset performance anomaly.

SAI is to be achieved through a self-learning optimization process, i.e. one intended to obtain the maximum effectiveness of an Asset. This involves data being parsed (possibly at different frequencies) and then certain patterns being detected: an incident becomes known to the system. Then the system provides a response/recommendation and predicts the future occurrence of a certain event. SAI using the PARCS™ engine can occur at individual component level within an Asset (compressor), the Asset (Turbine), system level (two aircraft turbines or MRO facility) or ecosystem (all airlines with the similar turbine or suppliers of compressor parts), and over time horizons—past, present and future.

The SAI process is carried out by means of a self-learning optimization engine. The engine gathers the device data at their source, possibly from Assets in motion (e.g. airlines), through edge cloud services. The typically enormous size of the collected data justifies the use of the expression Big Data to refer to them. Both the detection and response are done through application services, which mean they are running at (external) service provider premises. Lastly the prediction is often presented in a graphical manner, also referred as visualization.

The platform of the SAI optimization engine can be rapidly deployed in a Model-View-Presenter (MVP), i.e. is a user's graphical interface showing the outcomes of the statistical models. Moreover, the SAI optimization engines are economically designed using appropriate technologies and adapted to the specific needs of the customers. The edge cloud potentially allows the collection of high frequency data which could be exploited in economically disruptive ways. The SAI optimization model is designed to help determine the condition of in-service assets in order to predict when maintenance should be performed. This predictive maintenance will be more cost effective compared with routine or time-based preventive maintenance (often seen in Annual Maintenance Contracts) because maintenance tasks are performed only when required. Also a convenient scheduling of corrective actions is enabled, and one would usually see a reduction in unexpected device failure.

This is possible by performing periodic or continuous equipment condition monitoring. The accurate prediction of future device condition trends uses principles of data science to determine what type and at what point in the future maintenance activities will be appropriate. This is part of reliability-centered maintenance (RCM) which emphasizes the use of predictive maintenance techniques. In addition to traditional preventive measures, RCM seeks to provide companies with a tool for achieving lowest asset net present costs (NPC) for a given level of performance and risk.

Thus, in the development of SAI optimization models we will end up looking at computerized maintenance management systems (CMMS), distributed control systems (DCS) and certain protocols like Highway addressable remote transducer protocol (HART), IEC61850 and OLE for process control (OPC).

Sources of data can include non-destructive testing technologies (infrared, acoustic/ultrasound, corona detection, vibration analysis, wireless sensor network and other specific tests or sources). As well as data sourced from IT/Enterprise systems such as SAP, Maximo, Oracle ERP and industrial systems such as SCADA and/or Historians.

The self learning optimization model discussed takes SAI to the next level by putting the service requirement prediction of the device under consideration in the context of the service environment in which it is operating.

SAI delivers the following:
Near-zero device down time
Optimized device working time
Optimal device performance
Optimal device maintenance
Optimal cost of maintenance and the provision of spare parts and supplies
Optimal Health to manage life expectancy
Recommendation to ensure the allocation of Resources, such as spare parts and capacity utilization

### How is an SAI Optimization Model be Developed?

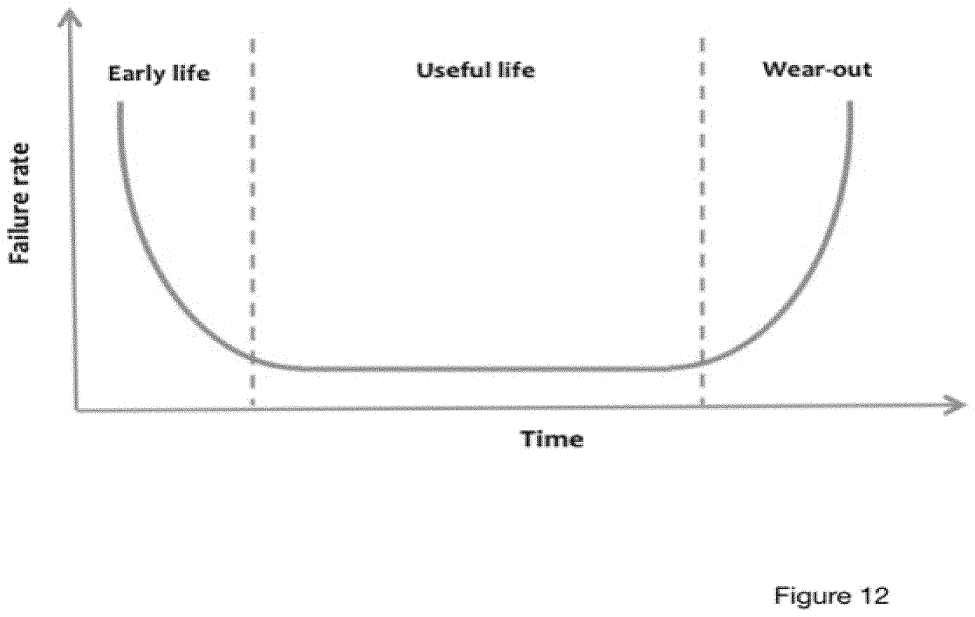

The SAI self-learning optimization model attempts to identify and predict the likelihood of any potential reason for failure of a device. Consider the well-known bathtub curve (Smith, et al, “The bathtub curve: an alternative explanation,” Reliability and Maintainability Symposium, 1994. Proceedings, Annual, pp. 241-247) in FIG. 12. This curve, named for its shape, depicts the failure rate over time of a device. A device life can be divided into three phases: Early Life, Useful Life and Wear Out. Each phase requires making different considerations to help avoid a failure at a critical or unexpected time because each phase is dominated by different concerns and failure mechanisms.

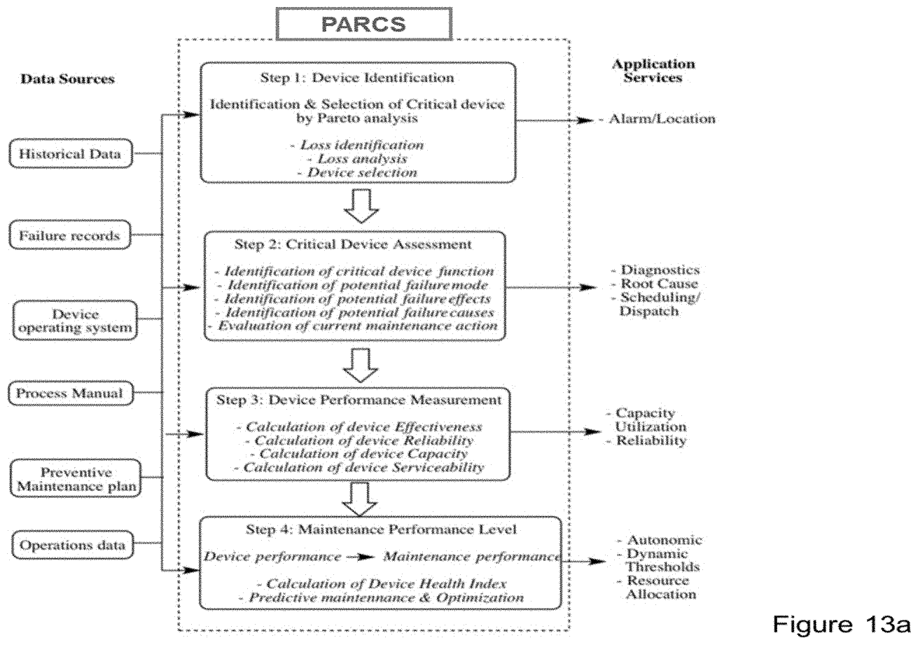

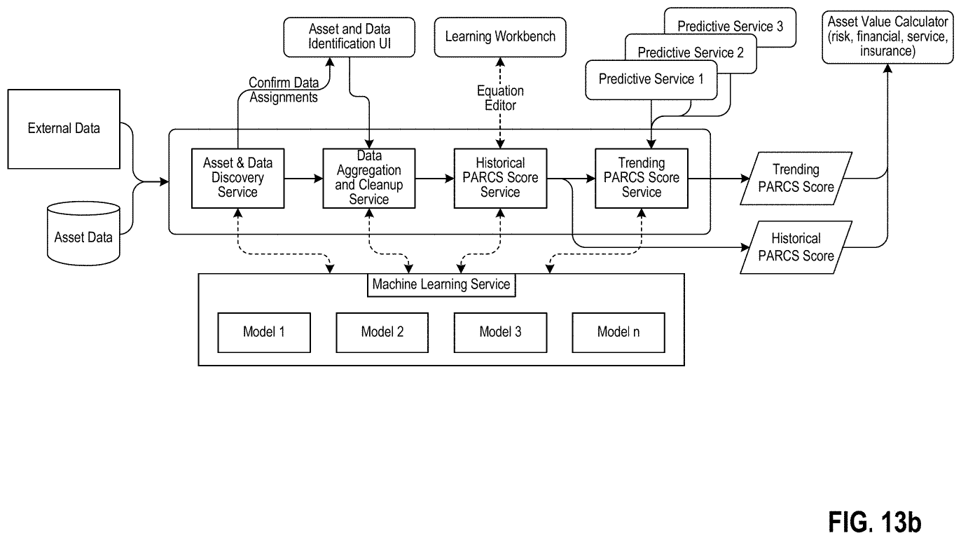

A major part in the normal function of an asset is regular maintenance to ensure the safe and reliable operation of equipment. Effective maintenance can be achieved ensuring a balance between the predicted needs and the PARCS™ parameters. The optimization model framework model—PARCS™—is shown graphically in FIG. 13a.

Salient features of PARCS™ model that enable SAI:
1. Input: The data from any source at any frequency into the model in the sequence given above.
2. Mathematical Processing: The instances and definitions of all dimensions of the asset are identified and calculated as follows:
   a. Performance: The performance of an asset relates to ensuring a balance between effectiveness (the tasks to operate the device to achieve a goal) and efficiency (the operation of the asset to optimize the processes, resources and time).
   b. Availability: Whether or not the asset is ready to use for the purpose intended by the manufacturer.
   c. Reliability: Reliability indices include measures of outage duration, frequency of outages, system availability, and response time. System reliability pertains to sustained interruptions and entry interruptions. An interruption of greater than five minutes is generally considered a reliability issue, but this depends on the system context.
   d. Capacity: Capacity is the capability of an asset to provide desired output per period of time—present and future.
   e. Serviceability: the measure of and the set of the features that support the ease, cost and speed of which corrective maintenance and preventive maintenance can be conducted on a system.
3. The model uses data science techniques to build customized statistical models for an asset or set of assets across certain categories of a dynamic data model (i.e. if different sets of data are captured by different customers/companies) to address any type of anomaly/fault/performance issue.
4. The output of the model then identifies ‘best solution—recommended by model’ and other possible solutions which the customer/company can use to over-ride the ‘best solution’ recommended by the self-learning optimization algorithm.
5. Output: The PARCS™ model output can be used for following application services such as:
   a. Insight/Location: Ability create future insights by probability of occurrence depending on the availability and accuracy of the data to create a predictive model. Network connectivity to determine location of the asset or plant.
   b. Root Cause: Determine potential root causes for an insight/event condition based on current and historical data.
   c. Reliability: Create for any device, plant or asset a reliability model to determine mean time to failure and probability of failure and impact of failure.
   d. Diagnostics: Real time or near real time data analysis of multiple metrics to determine performance against bench mark, efficiency metrics or standard operating condition.
   e. Scheduling & Dispatch: Analysis of current route, resources and inventory to recommend dispatch of crews with the right skills and assets to resolve an alarm or event condition.
   f. Dynamic Thresholds: Ability to configure and auto update set points, static data points (inventory levels) and device parameters to trigger insights and/or event conditions.
   g. Capacity Utilization: Analysis of current allocation and future projected allocation (reservations) to model capacity availability and make recommendations
   h. Resource allocation: Design of network plans and routes to determine the optimal method to source, distribute or allocate resources. Model trade off and generate model scenarios
   i. Autonomic: Continuous monitoring, adjusting and self-learning, ability to modify cause of action without intervention.

### Illustration of SAI Optimization Model

This is a demonstration of the SAI optimization model using failure data of a device given in the table below. This is a simple data set used to illustrate how some “−abilities” are calculated. Events are put into categories of up-time and down-time for a device. Because the data lacks specific failure details, the up-time intervals are often considered as generic age-to-failure data. Likewise, the specific maintenance details are often consider as generic repair times.

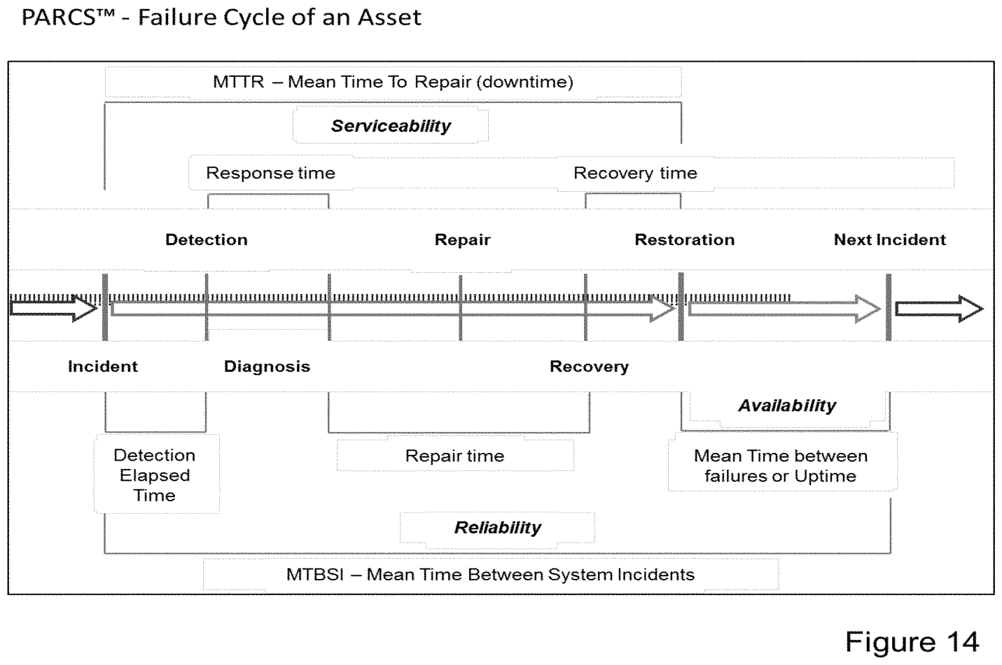

FIG. 14 Illustrates the failure cycle of an Asset.

| | Elapsed | Elapsed |
|---|---|---|
| Clock Hours | Time For | Time For |

| Start | End | Up Time | Down Time |
|---|---|---|---|
| 0 | 708.2 | 708.2 | |
| 708.2 | 711.7 | | 3.5 |
| 711.7 | 754.1 | 42.4 | |
| 754.1 | 754.7 | | 0.6 |
| 754.7 | 1867.5 | 1112.8 | |
| 1867.5 | 1887.4 | | 19.9 |
| 1887.4 | 2336.8 | 449.4 | |
| 2336.8 | 2348.9 | | 12.1 |
| 2348.9 | 4447.2 | 2098.3 | |
| 4447.2 | 4452 | | 4.8 |
| 4452 | 4559.6 | 107.6 | |
| 4559.6 | 4561.1 | | 1.5 |
| 4561.1 | 5443.9 | 882.8 | |
| 5443.9 | 5450.1 | | 6.2 |
| 5450.1 | 5629.4 | 179.3 | |
| 5629.4 | 5658.1 | | 28.7 |
| 5658.1 | 7108.7 | 1450.6 | |
| 7108.7 | 7116.5 | | 7.8 |
| 7116.5 | 7375.2 | 258.7 | |
| 7375.2 | 7384.9 | | 9.7 |
| 7384.9 | 7952.3 | 567.4 | |
| 7952.3 | 7967.5 | | 15.2 |
| 7967.5 | 8315.3 | 347.8 | |
| 8315.3 | 8317.8 | | 2.5 |
| | Total | 8205.3 | 112.5 |
| | MTBM= | 683.8 | |
| | MTTR= | | 9.4 |

Failure data for an Asset.

To calculate the optimization model parameters for this Asset:

Availability deals with the duration of up-time for operations and is a measure of how often the system is alive and well. Availability is defined as

$$A ( t ) = \frac{MTBM}{MTBM + MTTR} ,$$

where
MTBM=Mean Time Between Maintenance
MTTR=Mean Time To Repair

Using the data set provided in the table above, the availability of device is 98.6% based on MTBM=8205.3 hours and MTTR=112.5 hours.

Reliability deals with reducing the frequency of failures over a time interval and is a measure of the probability for failure-free operation during a given interval, i.e., it is a measure of success for a failure free operation. It is often expressed as

$$R ( t ) = exp ( - \frac{t}{MTBF} ) = exp ( - λ t )$$

where X is constant failure rate and MTBF is mean time between failure (same as MTBM). MTBF measures the time between system failures.

The data in the table above shows the mean time between maintenance is 683.8 hours. If we want to calculate the device reliability for a period of one year (8760 hours). The device has a reliability of exp(−8760/683.8)=0.00027%. The reliability value is the probability of completing the one year operation without failure. In short, the system is highly unreliable (for a one year time) and maintenance requirement is high as the device is expected to have 8760/683.8=12.8 maintenance actions per year.

The above calculations for reliability were done by available historical data given in the table above. The more accurate predictions will be found by building a probability plot from the data in the table above. This probability plot shows the mean time between maintenance events is 730 hours.

Serviceability deals with duration of service outages or how long it takes to achieve (ease and speed) the service actions. The mathematical formulae is expressed as

$$S ( t ) = 1 - exp ( - \frac{t}{MTTR} ) = 1 - exp ( - st )$$

where S is constant service rate and MTTR is mean time to repair.

Data in the table above shows mean down time due to service is 9.4 hours. If we want to calculate the device serviceability with an allowed repair time of 10 hours. The device has a Serviceability of 1-exp(−10/9.4)=65.5%. The serviceability value is the probability of completing the repairs in the allowed interval of 10 hours. Therefore, the device has a modest serviceability value (for the allowed repair interval of 10 hours).

The above calculations for serviceability were done using available historical data given in the table above. The more accurate predictions will be found by building a probability plot from the data in the table above. This probability plot shows the mean time to repair is 10 hours.

Thus, the SAI Optimization Model allows:
1. Identification of the problem/anomaly/potential failure for a device and criticality of failure through PARCS™ model
   a. Prediction of failure Insight/anomaly/performance issues—what type of failure will occur?
   b. Prediction of time of failure/anomaly/performance issues—when will the failure occur?
2. Identification of possible ‘on the ground’ solutions available for failure/anomaly/performance issues and the best possible working solution so that the customer/company can understand the:
   a. Time to start service—when can the solution to the failure start?
   b. Time to service—how long will it take to have the device in optimal working condition?

The SAI Optimization Model Is a holistic model which gives solutions for predicting and resolving failures/anomalies and/or performance issues.

FIG. 13b PARCS™ engine provide a detailed technical explanation of the architecture. The core components of Asset Discovery and Asset Value provide:
i. The core data for PARCS™ (i.e. the minimum required for the calculations) include at least one year of history for each asset from Asset Management and/or Asset Performance systems:
   1. Production—number of units produced per unit time
   2. Maintenance type—the recurring maintenance and corresponding dates
   3. Repair time—the time it takes to perform each maintenance procedure
   4. Failure/Downtime—the downtime of the device and date
   5. Capacity—the maximum production of each asset
ii. PARCS™ data store: An accumulation of all asset data used to calculate PARCS™ scores will be stored on the distributed file system (part of Machine Learning Services).
iii. Asset Value Calculator: This service(s) is used to apply the PARCS™ scores to additional contexts such as risk prediction, insurance/warranty models, and financial planning. These services are outside of the scope of PARCS™, although they are closely connected. The asset value calculators depend on external data sources that provide insight into additional contexts above.

### Application of SAI

FIG. 21 illustrates utilization of systems according to the invention by industry “verticals,” enterprises in the Aerospace, Marine, Oil & Gas, and Manufacturing industries, by way of non-limiting example. SAI with the PARCS™ engine presents advantages to such industries when used in connection with other aspects of the illustrated invention, e.g., those pertaining to edge cloud services, cloud in a box, billing engine, and PARCS™. Those advantages include enabling creation of cloud-native (i.e., no downtime) SaaS (software as a service) industrial applications. Such applications, which can be used on a pay as you go basis, are configurable to industry verticals and enable industrial engineers to self-provision assets, control data ingestion, perform predictive analytics and create maintenance, warranty and risk management applications to support their business, domain and industry needs.

### Smart Device Integration

Described below is the architecture of a smart device integration a key piece of capability for assets with smart sensors—sensors that are self discoverable, automatically connect to Wifi, Bluetooth, and ZigBee. These sensors will connect to IOT gateways and/or directly to Cloud in a Box appliances and communicate through Edge Cloud Services defined earlier.

### An Example of Smart Device Integration:

The intention behind building this device, and a system according to the invention in which it is embodied, is to measure different gas levels in the atmosphere at different parts of geography & send all these measured variables & locations to Edge Cloud to be get transmitted over Internet where it can be analyzed and accessed through one URI. The weather at each location depends mostly on presence of these gases. Excess of these gases can cause pollution to environment & very serious harms to human being.

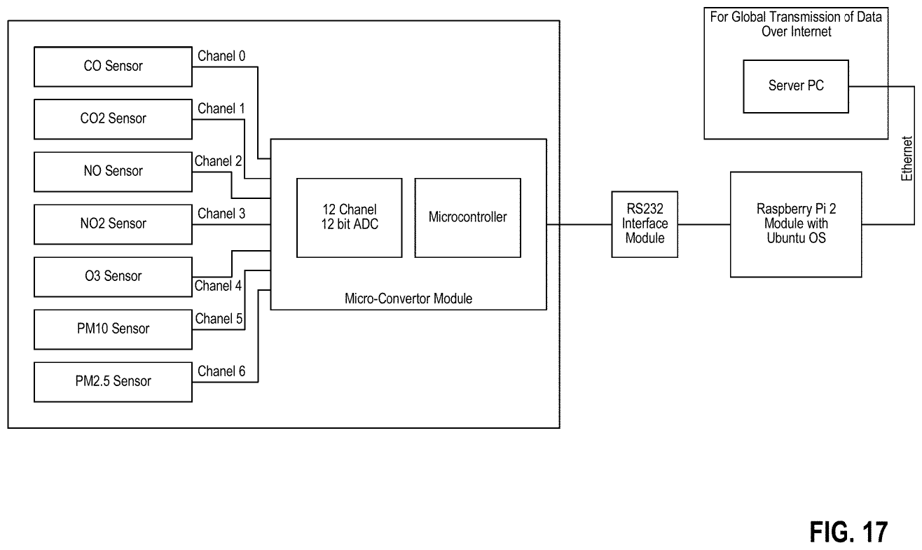

FIG. 17 depicts a smart device according to the invention and a system in which it is embodied.

Here we decided to measure CO, CO2, NO, NO2, O3, PM10 & PM2.5 contents in PPM. A sensor for CO & LPG measuring was connected (MQ7—CO Sensor, MQ5—LPG sensor)—individual sensor modules were used had their own supply & analog output circuitry. Sensors were connected to a Raspberry Pi1 & Raspberry Pi2 module as gateway.

The sensors used in the illustrated embodiment include those described below.

MQ7 Sensor: CO Sensor (for Example from Sparkfun)

### Features:

1. Highly sensitive to Carbon monoxide
2. Stable output
3. Operating voltage: +5V DC
4. Operating Temperature: −20° C. to +80° C.
5. Analog output proportional to gas sensed in PPM.
6. Detection Range: 20PPM to 2000PPM
   MQ5 Sensor: LPG Sensor (for Example from Seeed Studio)

### Features

1. Highly sensitive to LPG
2. Stable output
3. Operating voltage: +5V DC
4. Operating Temperature: −20° C. to +80° C.
5. Analog output proportional to gas sensed in PPM.
6. Detection Range: 200 PPM to 10000 PPM
   MG811 Sensor: CO2 Sensor (for Example from Sandbox Electronics)

### Features:

1. Highly sensitive to Carbon Dioxide
2. Stable output
3. Operating voltage: +5V DC
4. Operating Temperature: −20° C. to +80° C.
5. Analog output proportional to gas sensed in PPM.
6. Detection Range:

The illustrated smart device incorporates, as a microconverter module, an EVAL ADuC832 evaluation board available from Analog Devices.

### Features:

1. Simple 89X52 Core Microcontroller
2. 3.3V to 5.0V DC Operating voltage
3. Inbuilt 12 bit, 12 channel single ADC, 12 bit dual DAC
4. Serial Communications like SPI, I2C, UART
5. Battery operated operations can be possible for long time

### Microcomputer

The microcomputer utilized in the embodiment of FIG. 17 is the Raspberry Pi—2 (B) Model Board

### Features:

1. Smallest Micro-mini single board computer
2. GPIO available for external interface & control
3. 4 USB port, 1 Ethernet port
4. Micro-SD Memory Card
5. Audio/Video Output
6. Can power up with 5V/200 mA DC adaptor

All of the sensors give an analog output proportional to amount of gas sensed in PPM. This analog signal can't be directly connected to edge cloud services or to the RPi board, since PC or RPi doesn't have their inbuilt analog to digital convertors (ADC). The interface required either external serial ADC or another convertor which will/can directly read these analog signals of multiple sensors & can give direct digital data in our required format to edge cloud services.

Here we have used a simple convertor micro-controller board of “Analog Devices” 7—the “EVAL ADuC832”. It is 89X52 core 8 bit microcontroller having inbuilt 12 bit ADC with 12 channels. I.e. allows the ability to connect at max 12 sensors to this board. This micro-convertor board with some program burnt in it will then select one sensor Chanel one by one sequentially & will read its output & will give direct digital read out at its serial terminal which then can be directly connected to the edge cloud services to display on via a visualization tool

### Operations

The system of FIG. 17 is divided in three parts: A micro-convertor unit with Sensor module interface, a communication bridge of RS232 & a micro-computer. The micro-convertor has inbuilt 12 bit 12 channel single ADC i.e. we can interface 12 different sensors to single micro-convertor or in other word a single micro-convertor can take care of 12 different sensors at a time to read data from them & send it to microcomputer. A very small-embedded code is required to burn in this micro-convertor to read data from ADC. Micro-converter has three types of Serial Interface to external world as SPI (Serial Peripheral Interface), I2C (Inter-Interconnect Communication) & UART or RS232 (Universal Asynchronous Receiver Transmitter). Use of RS232 interface since it can give us debug capability in testing & servicing point of view. Just by decoupling micro-converter & microcomputer board we can check the output of micro-convertor on the edge cloud services.

The next part is a RS232 bridge, which acts as an interface between micro-convertor & microcomputer. The micro-convertor is sending data at baud rate of 9600 to external interface. This data is then given to RS232 pins (RXD & TXD pins) Raspberry Pi board (Pins 8 & 10).

In Raspberry Pi the operating system used was an Raspbian Wheezy as well as Snappy OS. Development via edge cloud services to connect and ingest data.

Possible modifications, features and other characteristics of the illustrated embodiment follow:

Components selected for the illustrated embodiment are all by way of example. E.g., any microcontroller with inbuilt ADC & UART can be used (e.g., LPC2148 micro-controller, which is a power full ARM-7 series of micro-controller). However, system integration and cost of device in customized equipment with compared to ADuC832 can be higher and programming more complex.

For Sensor assembly care should be taken of fixture design such that local air (The environment where sensor & unit is installed) should get flown on every sensor. Also Sensors should not get directly exposed to open environment such as direct rain, storm, flame or other hazardous conditions like electrical sparks etc.

Source of power is important—depending on whether power is from a battery or mains supply. It is suggested to keep power of system mains operated in normal operation mode & keep battery operation in case of mains power failure. Battery operation requires rechargeable batteries with its charging circuit. Also our main system of micro-converter & microcomputer requires very less energy (3.3V/300 mA=0.99 W==1 W approx.). But if you consider sensor part, each of sensors requires about 5V DC & about 50 mA to 100 mA of current. There for while designing a compact system a special care is required to be taken while designing its power supply section. A separate 3.3V & 5V power supply section is required with their different current requirements.

UART Bridge is preferred between micro-converter & microcomputer, since it gives a facility of debugging & checking output of micro-convertor unit.

### Smart Device Communications

This section outlines communication protocol between SmartDevice and the Edge Cloud. SmartDevice communicates with an Edge Cloud for archiving and analysing data. This data exchange can be of various types.

Packet Format

| | | | | | |
|---|---|---|---|---|---|
| PACKET ID | SMARTDEVICE | DATETIME | TYPE | DOCKETID | SEQUENCEID |
| | ID | | | (Optional) | (Optional) |

REQUEST TYPE

| Type | Description |
|---|---|
| QUERY | Query to SmartDevice from Edge Cloud |
| RESPONSE | Response data to Edge Cloud |
| CONFIG | Calibration/configuration of any function code |
| | to SmartDevice |
| CONFIGRESPONSE | The result of the Configuration requested on |
| | the SmartDevice. |
| ACTIVATE | This will make SmartDevice's handshake |
| | with Edge Cloud |
| QUERY_ALL | To query all values of sensor |
| COMMAND | SmartDevice will ask to Edge Cloud for |
| | commands to process. |
| ALERT | Alert message from SmartDevice to Edge |
| | Cloud |

Terms Used with Description:
Edge Cloud: The QIO Edge Cloud Setup.
SmartDevice: A SmartDevice which sends data to Edge Cloud.
packet: Envelope of GPRS data packet in xml.
id: Attribute that represent this current communication through packet.
SmartDeviceid: ID of SmartDevice.
datetime: Attribute to contain timestamp. FORMAT:[DDMMYYYY-HH:MM[AM/PM]]
type: Type of packet containing data as described in above table.
sensor: XML element to contain sensor data.
key: Used as key for sensorid or functioned.
value: Value of sensor or for function.
sequenceid: Usend while transferring large data from Edge Cloud SmartDevice to data.Example:“1-5” means that 1st packet of the 5 packets.

### XML Packet Format for Activate SmartDevice

<packet SmartDeviceid=“SmartDevice 4” datetime=“27022015-12:40 PM” type=“ACTIVATE” passkey=“HASHED_KEY”></packet>

This packet will make a handshake between Edge Cloud & SmartDevice. Only after a handshake has happened Edge Cloud will start accepting data.

### XML Packet Format for Notification

<packet id=”5” SmartDeviceid=”SmartDevice 4”
datetime=”27022015-12:40PM” type=”RESPONSE”
seesionkey=”encrypted_session_key”>
<sensor key=”QIONO2” value=”38.5” max=”37.7”
message=” CHECK”/>
<sensor key=”QIOO3” value=”38.5” max=”37.7” message=”CHECK”/>
<sensor key=”QIOCO” value=”33.5” min=”37.7”
message=”NORMAL”/>
<sensor key=”QIOCO2” value=”” max=”” message=”NORMAL”/>
<sensor key=”QIOGPS” value=“18.4937116,73.9177”/>
</packet>

Format for sending sensor data as notifications to Edge Cloud for SmartDevice. Request id is optional in this format. If SmartDevice is posting data to Edge Cloud on request then it will contain request id. If its posting data on time intervals then it will be blank.

### XML Packet Format for Alert

<packet id=”5” SmartDeviceid=”SmartDevice 4”
datetime=”27022015-12:40PM” type=”ALERT”
seesionkey=”encrypted_session_key”>
<sensor key=”QIOCO” value=”63.5” max=”37.7”
message=”HIGH”/>
</packet>

Format for sending sensor data as notifications to Edge Cloud for SmartDevice. Request id is optional in this format. If SmartDevice is posting data to Edge Cloud on request then it will contain request id. If its posting data on time intervals then it will be blank.

### XML Packet Format for Function Code

<packet id=”5” SmartDeviceid=”SmartDevice 4”
datetime=”27022015-12:40PM” type=”CONFIG”
seesionkey=”encrypted_session_key”>
<function key=”60” value=”56” />
<function key=”72” value=”34”/>
</packet>

This format of packet is used to set function values of the SmartDevice. Here, the type of packet is “CONFIG”. Function elements will contain function id's & values to set. When this process of resetting will be completed SmartDevice will send empty packet with same id & type as “RESPONSE”.

### EXAMPLE

<packet id=”5” SmartDeviceid=”SmartDevice 4”
datetime=”27022015-12:40PM” type=”CONFIGRESPONSE”
seesionkey=”encrypted_session_key”>
<function key=”60” value=”56” errorcode=”something” />
<function key=”72” value=”31” errorcode”something”/>
</packet>

### XML Packet Format for Command

<packet SmartDeviceid=”SmartDevice 4”
datetime=”27022015-12:40PM” type=”COMMAND”
seesionkey=”encrypted_session_key”>
</packet>

Format sent from SmartDevice to Edge Cloud for asking Edge Cloud if there is anything for SmartDevice or not.

### XML Packet Format for Query

```
<packet id=”456” SmartDeviceid=”SmartDevice 4”
datetime=”27022015-12:40PM” type=”QUERY”
seesionkey=”encrypted_session_key”>
      <sensor key=” QIOCO2” />
      <sensor key=” QIOGPS” />
</packet>
```

This format is sent from Edge Cloud to SmartDevice for querying sensors given in the packet. In response to this SmartDevice will send the following packet format with same id & type as “RESPONSE”.

<packet id=”456” SmartDeviceid=”SmartDevice 4”
datetime=”27022015-12:40PM” type=”RESPONSE”
seesionkey=”encrypted_session_key”>
<sensor key=”QIOCO2” value=”” max=”” message=”NORMAL”/>
<sensor key=”QIOGPS” value=“18.4937116,73.9177”/>
</packet>

### XML Packet Format for Query ALL

<packet id=”456” SmartDeviceid=”SmartDevice 4”
datetime=”27022015-12:40PM” type=”QUERY_ALL”
seesionkey=”encrypted_session_key”>
</packet>

Format sent from Edge Cloud to SmartDevice for querying all sensors present in SmartDevice. In response to this SmartDevice will send the following packet format with same id & type as “RESPONSE” with current data of all sensors.

<packet id=”456” SmartDeviceid=”SmartDevice 4”
datetime=”27022015-12:40PM” type=”RESPONSE”
seesionkey=”encrypted_session_key”>
<sensor key=”QIONO2” value=”38.5” max=”37.7”
message=” CHECK”/>
<sensor key=”QIOO3” value=”38.5” max=”37.7” message=”CHECK”/>
<sensor key=”QIOCO” value=”33.5” min=”37.7”
message=”NORMAL”/>
<sensor key=”QIOCO2” value=”” max=”” message=”NORMAL”/>
<sensor key=”QIOGPS” value=“18.4937116,73.9177”/>
</packet>

### RESTful Web Services

### Edge Cloud RESTful Web Services

The RESTful web service on Edge Cloud would exposes the following functions used for communication.
1. ActivateSmartDevice
2. PostToSystem
3. FetchRequestXML

### Description of the Web Service Functions

### 1. ActivateSmartDevice

This function call will activate SmartDevice to start accepting data further. Unless the SmartDevice is in activated mode data will not be accepted. But before this SmartDevice should be registered into the system. The XML format needed for this is as below:

### Request:

<packet id=””SmartDeviceid=“SmartDevice 4” datetime=“10092015-12:40 PM” type=“ACTIVATE” seesionkey=“encrypted session key”></packet>
Section underlined is mandatory.

### Response:

“OK”—On Success
“BadRequest”—On failure

After invoking web service to activate SmartDevice, if successfully activated, it will return “OK” status code. Otherwise it will return “BadRequest”.

### 2. PostToSystem

This function is used by the SmartDevice to post data to the system and generate notifications for respective SmartDevices features. Note that this data will be accepted to system if & only if SmartDevice is registered & SmartDevice is activated. All the packets with type “RESPONSE” should be posted to this function

### Response:

“OK”—On Success
“BadRequest”—On failure

### 3. FetchRequestXML

This function is used by SmartDevice to fetch request or command xml from the Edge Cloud & process further according to that. Note that this function will return a xml string which be either to set configuration of the SmartDevice or to query sensor values.

### Response:

“REQUEST_XML_STRING”—On Success
“BadRequest”—On failure

If there is any error at edge cloud then edge cloud will reply as “edge cloud error”

### PARCS™ Architecture for Sustainability Index

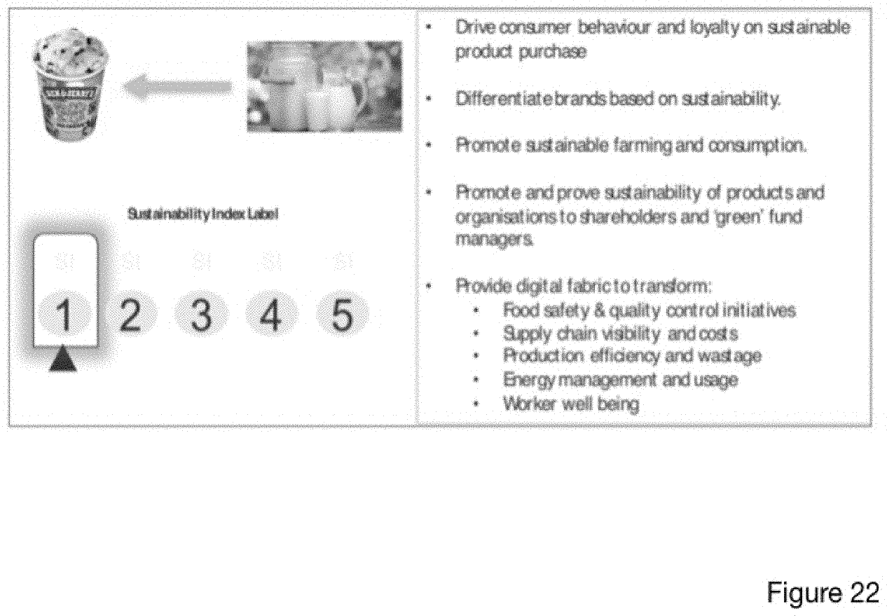

Some embodiments of the invention provide a Sustainability Index feature, building on the PARCS™ model discussed above, to collect data across the supply chain, e.g., from the farmer to the retailer, and create a sustainability index that can then be shown on each consumer product to drive smarter buying habits. The analogy is the Energy Index shown on electrical products such as washing machines, to illustrate the cost of energy consumption per annum. FIG. 22 below illustrates how such a sustainability index is used

### Foresight Engine Framework

A benefit of the foregoing is to provide Industrial Engineers with a workbench for developing, collaborating and deploying reusable Systemic Asset Intelligence analytics and applications. Embodiments of the invention constructed and operated as discussed above and adapted for systemic asset intelligence (referred to below, as the “NAUTILIAN Foresight Engine”) comprise cloud-based software that supersedes legacy modelling tools such as Matlab and OSlsoft PI for Industrial Engineers to collaborate on data ingestion, asset models (pumps, compressors, valves etc.), analytical models (vibration, oil temperature, EWMA) using standard software libraries in R, Python, Scala etc. and a user interface where engineering communities can share, critique and deploy code to rapidly develop cloud native predictive applications. NAUTILIAN Foresight Engine is a toolkit, with open interfaces and a SDK (software development kit) for Engineers (physical sciences and computer science) to collaborate, and has the following key features:

Ingestion Manager: to connect, extract, filter, standardize and load data from any source (machine or human generated), at any frequency (streaming, snapshot, or batch);

Asset Discovery: to provide a default set of visualizations, parameters, manufacturer configurations and allow the user to define reusable mathematical functions, relationships and metadata;

User Profiler: ability to create user personas (roles and responsibilities) tied to organizational structure and relationships. Allowing the ability to control users and group access rights to view, modify and delete;

Analytical/Machine Learning Framework (PARCS): for industrial and software engineers to write code in Java, R, Scala, Python etc. creating analytics that monitor & predict the behaviour of an asset, group of assets or system over time periods, and generate confidence indices and diagnostic networks to validate the accuracy of the analytical models;

Insight Manager: to visualize, share and distribute charts to review and get feedback. Analytics generated as anomalies can be reviewed, commented on and tracked across engineering teams. Workflows can be configured to route specific anomalies to engineering teams and feedback captured.

At the core of Foresight Engine is PARCS, providing a multi-dimensional view of any industrial system and the interconnections to systems. Providing a Digital Twin of the physical asset, through logical data definitions and parameter configurations.

### 1. NAUTILIAN Platform

### Architecture

The NAUTILIAN™ Platform provides manufacturing and industrial customers with a software framework of open services to create industrial agility, where engineers can experiment, rapidly test mathematical models and develop smart applications. NAUTILIAN™ is a horizontal platform based on open-source technologies and is cloud neutral.

Foresight Engine is deployed on NAUTILIAN Platform as set of microservices.

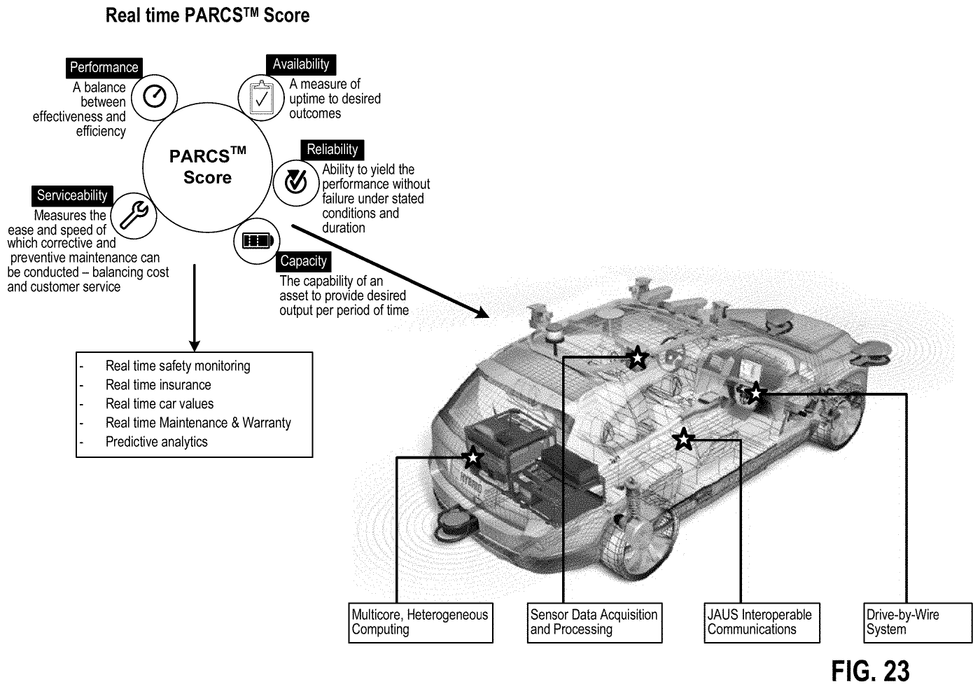

An overview of the NAUTIAN Platform architecture is shown in FIG. 23 and discussed below.

### Components

### Infrastructure

Kubernetes is used to provide cloud neutrality and deploy NAUTILIAN Templates and applications anywhere. Docker images are used to deliver stateless and stateful microservices as containers.

### Responsible for:

Automating deployment;
Auto scaling; and
Management of containerized applications

### Component Catalog

Kubernetes Helm is used to provide installation scripts (Helm Charts) and offer a catalog of all components and application templates. The catalog is stored on Artifactory together with all Docker images used by the charts.

httpslidocker.qiotec.com:5555 is QiO's official Docker repository protected by secure layer.

### Identity Services

Provide the following functionality:
Provisioning of user accounts and assignment of roles and organizations to application features and functions
Auditing of all access and usage
Integration with third party identify services such as Active Directory and ability to provide Single Sign On.

Consists of:
Account Service; and
UI Components for:
   User,
   Roles,
   Groups, and
   Organization (Tenant) management.

Support the Oauth2 Standard, and JWT standard implementations.

### Edge Services

Provides integration to physical devices and sensors to extract, load and transform (ELT) time series data at speed and low cost, apply standards, and aggregate data at the edge. Edge Services support communication to various protocols such as BacNet, Modbus, Hart, etc., and convert proprietary protocols into standards such as OPC UA (Unified Architecture).

Integration with Blockchain (Guardtime KSI) provides digital asset identity services and validation of asset integration.

### Consists of:

OPC UA (via Softing) server running on the Cloud-in-a-Box (CiaB), or external gateways
OPC UA Client—responsible for connecting OPC Servers and Foresight Engine
Node-RED—IoT platform for easy configuration of gateways and IoT devices, translations of these protocols and communication with IoT broker on the Foresight Engine
Erlang Message Queue Telemetry Transport (eMQTT) Broker
   MQTT Broker
   TCP/SSL Connection
   MQTT Over WebSocket(SSL)
   HTTP Publish API
   STOMP protocol
   MQTT-SN Protocol
   CoAP Protocol
   STOMP over SockJS
Streaming Ingestion Services (Apache NiFi)

### Microservices

Microservices architecture and the associated application development refers to building software as a number of small independent processes which communicate with each other through language-agnostic APIs. The key is to have modular blocks which focus on a specific task and are highly decoupled so they can be easily swapped in and out rapidly with no detrimental effect.

The independent application features and functions, and APIs are self-contained, can be re-used and monitored across applications, and enable functionality to be scaled at a granular level.

The implementation of microservices follow these principles:

### Elasticity and Resilience

All microservices must be highly available and elastic so that they can scale up and down. For instance, Kubernetes uses the concept of replica sets to maintain a specified number of instances of a particular service to maintain availability and resiliency and Nautilian services leverage this functionality.

### Self-Healing and Design for Failure

Kubernetes provides this capability with liveness (indicate when to restart a container) and health (readiness to start accepting requests) checks. When liveness or health checks run, and they find that a particular service is not in a healthy state, the service will be killed and restarted. Combined with replica sets, Kubernetes will restore the service to maintain the desired number of replicas of a particular service. Nautilian provides the tooling for enabling liveness and health checks by default when services are deployed.

### Isolate Blast Radius of Failures

When dependent services, e.g. other microservices, databases, message queues, caches, etc., start to experience faults, the impact of the failure needs to be limited in scope to avoid potential cascading failures. At the application level, tools, such as Netflix Hystrix, provide bulkheading to compartmentalize functionality in order to:
Limit the number of callers affected by this failure
Shed load with circuit breakers
Limit the number of calls to a predefined set of threads that can withstand failures
Put a cap on how long a caller can assume the service is still working (timeouts on service calls). Without these limits, latency can make calls think the service is still functioning fine and continue sending traffic potentially further overwhelming the service.
Visualize this in a dynamic environment where services will be starting and stopping, potentially alleviating or amplifying faults

From the domain perspective, the service must be able to degrade gracefully when downstream components are faulting. This provides the benefit of limiting the blast radius of a faulting component, but how does a particular service maintain its service level? The use of

Hystrix enables providing fallback methods and workflows to allow a service to provide some level of service, possibly at a degraded level, in the event of dependent service failures.

Prove the System has been Designed for Failure

When a system is designed with failure in mind and able to withstand faults, a useful technique is to continuously prove whether or not this is true. Nautilian provides a tool that can access Kubernetes namespaces in environment, up to and including production, and randomly kill pods with running services. If a particular service was not designed to be able to withstand these types of faults, the Chaos Monkey tool will quickly provide that feedback.

### Service Discovery

Services are implemented to define a logical set of one or more pods to provide resiliency and elasticity for a particular microservice. Due to scaling requirements, resource utilization balancing, or hardware failures, pods related to a microservice can come and go. Service discovery enables the dynamic discovery of pods to be added, or removed, from the logical set of pods that are supporting the implemented service.

### Kubernetes Service Discovery

The default way to discover the pods for a Kubernetes services is via DNS names.

### Service Discovery Via DNS

For a service named foo-bar, the host name foo-bar might be hard coded in the application code.

For example, to access an HTTP URL use http://foo-bar/ or for HTTPS use https://foo-bar/(assuming the service is using the port 80 or 443 respectively). Or, if a non-standard port number is used, e.g. 1234, then that port number is appended to the URL such as http://foo-bar:1234/.

DNS works in Kubernetes by resolving to the service named foo-bar in the particular Kubernetes namespace being accessed where the application services are running. This provides the added benefit of not have having to configure applications with environment specific configuration and protects from inadvertently accessing a production service when working in a test environment. This also allows the application to be moved, i.e. its Docker images and Kubernetes metadata, into another environment and work without any changes.

### Load Balancing

When there is more than one pod implementing a particular service, Kubernetes service discovery automatically enables load balancing of requests across the related pods. To expose these services, such as APIs and UIs, the Rancher Kubernetes ingress load balancer provider will be used.

### Logging

To properly capture logs, when microservices are written, developers should:
Write logs to standard output rather than to files on disk
Ideally, use JSON output so that it is easy to automatically parse
All logs are archived and available for elastic search

### Monitoring

Capturing historical metrics is essential to diagnose issues involving microservices. These metrics are also useful for auto scaling of services based on load.

Nautilian uses Prometheus as the back end storage service and REST API to capture metrics, and then Graphana is used as the console to view, query, and analyse the metrics.

Each microservice will implement metrics capture, and reporting.

### Configuration

For microservice names and locations, Kubernetes service discovery will be used.

With respect to sensitive information, such as passwords, ssh keys, and OAuth tokens, Kubernetes secrets will be used rather than storing this type of information in a pod definition or in a docker image.

### API Framework

Used to create reusable APIs to access source and target systems and applications without direct point to point interfaces. Includes ability to monitor the performance and usage of APIs per application and system usage.

Consists of:
Microservice SDK—for rapid development of reach APIs
   Built on Java, Spring BOOT, Spring Data Rest, Mongo DB
   JSON Schema driven model design
   RESTful services
   RSQL Query library
   Versioned read-only resource library
   Coarse and fine grained authorization
   Security Library
   Test Client
   Monitoring plugins
   Docker wrapper
   Helm chart
Python Template
Integration Templates
Dynamic CRUD API Framework for runtime configuration and deployment of REST—APIs—no coding required.

### Messaging Services

Ability to publish standard integration message, route to subscribers, process contributions by subscribers, integrate with workflow services and complete business event/transactions.

Consists of:
Kafka Cluster—Apache Kafka™ is a distributed streaming platform that provides three key capabilities:
   Publish and subscribe to streams of records (In this respect it is similar to a message queue or enterprise messaging system)
   Store streams of records in a fault-tolerant way
   Process streams of records as they occur
Zookeper Cluster

### Workflow Services

Provides the ability to create, test and deploy workflow rules and agents to simplify business processes, data validation and automate user actions based on business rules and configurations. And, to monitor performance of workflow rules and configurations.

Consists of:
Case management services built on Spring State Machine Libraries
Activiti BPM to design new workflow rules and deploy

### Integration Services

Provides an integration toolkit for accessing batch, real time and near real time data—cleaning the data, reformatting, and integration with other applications.

Consists of:
Mulesoft Generic Integration Service
Microservice Templates and best practice implementations

### Development Services

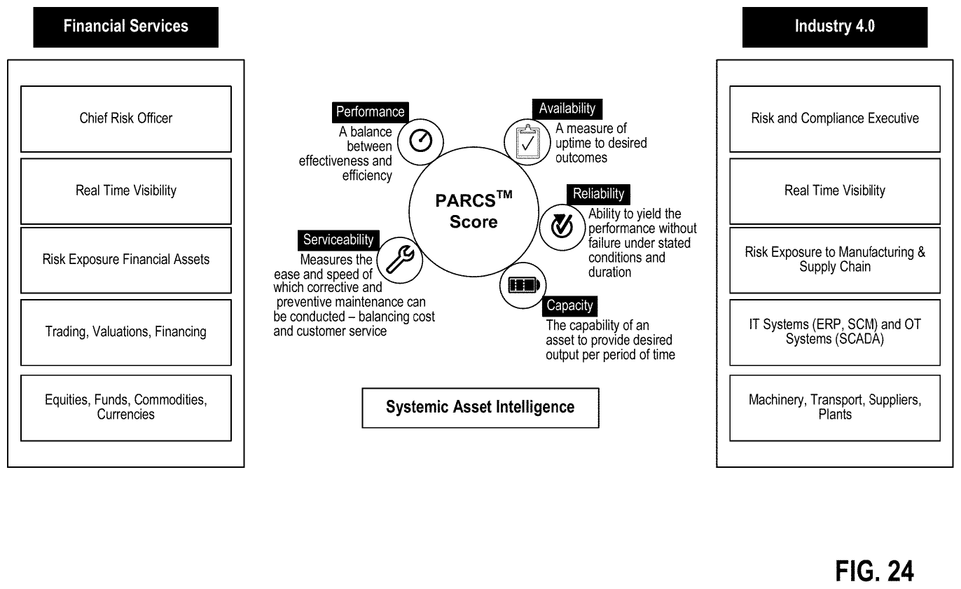

Referring to FIG. 24, the DevCloud provides an integrated, collaborative software development, build, release and test environment to enable and support continuous development and continuous integration. Leveraging the DevCloud, Agile Software Development practices enable iterative, collaborative software development based on continuous dialogue between software developers and users of the application.

### Self Service Provisioning

Menu of catalog services with service levels, pricing and default configurations that allows a PaaS admin to select standard services and deploy these for a customer tenant with minimal manual intervention and direction.

Catalog: List of PaaS services per customer tenant(s) to provision Data, LAMBDA, Asset and Analytical services. Each service has a service owner, price and SLA

Billing: The ability to monitor consumption by tenant and asset on a real time basis for all services consumed, and the ability to then automatically generate an invoice for payment. Tracking of payment against services, ability to accept payment by PayPal, Credit Card or Purchase Order.

Consists of:
Provisioning UI
Helm Catalog
Billing Engine

### Data Services (Data Lake)

Provide the ability to connect to different data sources with multi-tenancy at the asset and tenant level, with varying time horizons (milliseconds, seconds to snapshots), and to extract, transform and load the data into structured and non-structured databases. The consumption of data loaded into big data technologies, such as Cassandra and Hadoop, are provided via direct access tools, such as Hive, BI tools, and via RESTful API's.

The following provides an overview of the data services technologies employed in the Nautilian™ Platform.

### Apache Hadoop HDFS

Hadoop Filesystem used for fault tolerant distributed storage of large volumes of all types of data.

### HIVE—MariaDB

Used for metadata and transactional data storage. Hive is used in conjunction with HDFS and provides a SQL-like query interface to Hadoop filesystems. MariaDB is a relational database that is used by the Hive metastore repository to maintain the metadata for Hive tables and partitions.

Additionally, MariaDB provides a relational SQL repository for transactional data.

### MongoDB

Distributed document database storage using JSON-like documents that can allow the data structure to change over time. MongoDB is used predominantly for APIs.

### Apache Cassandra

Distributed DB for time series and large volume storage. Apache Cassandra is an open-source distributed NoSQL database platform that provides high availability without a single point of failure. Cassandra's data model is an excellent fit for handling data in Time Series, regardless of data type or size.

### Redis

In-memory database for key value storage used for caching and fast access.

### Elastic Search

Distributed RESTful search engine for dealing with unstructured and semi structured data.

### AWS S3

AWS S3 (Simple Storage Service) is an object based storage system with high durability that is used for archiving the incoming data ingestion feeds for reference.

Real-Time and Batch: LAMBDA Architecture

Provides the ability to simultaneously ingest real time streaming data and batch data, and to perform calculations and analysis in memory to provide outputs from one model to another in parallel while leveraging data in motion (in memory) and data at rest (data stores).

The Lambda Architecture aims to satisfy the needs for a robust system that is fault-tolerant, both against hardware failures and human mistakes, being able to serve a wide range of workloads and use cases, and in which low-latency reads and updates are required.

Consists of:
Apache Spark Cluster—General purpose cluster computing
Serverless Services—Runtime deployment of Machine Learning Models
   Python
   Java
   Scala
   PMML
Machine Learning Libraries
   Spark ML—Spark's machine learning library
   H₂O—ML and predictive analytics
   TensorFlow—Neural networks, high dimensionality

### Data Provenance—Via Guardtime KSI

Assignment of cryptographic keys (via Guardtime Blockchain Keyless Signature Infrastructure—KSI) to create digital identities and ensure any device connection is provided with a KSI key to ensure trust of the device.

Assignment of KSI key to customer tenant data to ensure data resides in only approved and authorized cloud environments, any unauthorized access or movement of data outside of approved cloud environments is immediately known.

Allocation of KSI identity to PARCS™ score to allow the creation of Digital Register per asset and ensure complete traceability and governance of all asset data across Cloud instances and changes.

### Visualization Services

Rich UI interface allowing users to interact with visual charts, maps, videos, chat, presence, notifications etc. Visualize complex analytical charts and ability to change configuration/settings of charts provided.

### UI Builder

Framework for Runtime Configurations and Customizations of all User Interfaces delivered via application templates.

Consists of:
Main UI Console
Catalog of basic Web Components
Catalog of Modules (coarse Web Components)—e.g. User management, CRUD Models etc.
Catalog of Layouts
Catalog of white-labelled Look and Feel options

### 2. Foresight Engine

### Data Flow Diagram

Referring to FIG. 25, the Foresight Engine is built on top of the NAUTILIAN Platform utilizing all the above mentioned services and is as set of microservices.

### Components

### Ingestion Manager

UI to load data sources (Realtime, Batch—Any data type, and any frequency) and normalize and standardize.

Utilizes NAUTILIAN Platform Edge Services and Integration services.

Consists of:
Ingestion Metadata Services—Storage of ingestion configurations
User Interface to Configure:
   Data Sources
   Transformations
   Normalization Rules
   Destination topics
Data preparation service—
   Automatic discovery of attributes
   Data cleansing
   Data wrangling

### Asset Discovery

Provides a default set of visualizations, parameters, manufacturer configurations and allow the user to define reusable mathematical functions, relationships and metadata.

Consists of:
Asset Metadata Services—storage of metadata related to Assets:
   Asset types
   Behaviours
   Models—Functions associated with assets
   PARCS™ domain model
Models for auto discovery
Asset Inventory Services—for managing existing assets and keep the history

### Insight Manager

Visualize, share and distribute charts to review and get feedback. Analytics generated as anomalies can be reviewed, commented on and tracked across engineering teams. Workflows can be configured to route specific anomalies to engineering teams and feedback captured.

Consists of:
Insight Metadata—Configurations for insights
Insight Service—Evaluate rules and executes workflows
Insight Notifier—Notification services per user or groups of users
Insight Collaboration Services—Messaging, chat, notification, file exchange
Insight personal dashboard

### Analytical/Machine Learning Framework (see PARCS™)

Used by industrial and software engineers to write code in Java, R, Scala, Python etc. creating analytics that monitor & predict the behaviour of an asset, group of assets or system over time periods, and generate confidence indices and diagnostic networks to validate the accuracy of the analytical models.

Utilizes NAUTILIAN Platform services for real time streaming and batch execution of machine learning (ML) algorithms, such as Spark ML, H2O, TensorFlow, etc.

Consists of:
Notebook—interactive data science and scientific computing across all programming languages
ML Metadata services—storage for model repository and description
Model Deployer—Serverless
Model Validator
Model Life Cycle Manager
PARCS™ models

### Template Manager

The QiO solution provides re-usable application templates to accelerate the development of bespoke applications with all the scaffolding and best-practices of mobile-responsive web applications already baked in.

This allows rapid development of business ready applications, in production with low cost and good quality.

An example of an application template would be the Predictive Maintenance template which would be installed on Foresight Engine. Configuring the organizational structure and adding users through user management would provide the basic application framework to develop a Predictive Maintenance application that can be enhanced over time.

Consists of:
Workflow Rules
Visualization Services
Predictive Maintenance Template
System Services
User Management
Organizational Structure

### 3. PARCS™ Engine Overview

The PARCS™ scores are based on asset specific data including asset type, asset characteristics, sensor data, and historical log data. In principle, the goal is to have the PARCS™ architecture auto detect the asset type, read asset type characteristics from a database, and automatically identify and clean sensor data and log data. The functionality requires a significant amount of data for each asset, which is not always the case. Therefore, we will require user approval for some calculations. Furthermore, the use of ontology that relate asset types to one another so that we can map new data to related historical data used to train our models.

The asset type ontology is used to group together similar assets based on their features. Leveraging existing data to define reference states, i.e. statistical description of historical performance, reliability, etc. Then, the reference states can be used to normalize new data into a Z-score metric. The PARCS™ Z-score metrics can be applied even in cases when there are minimal amounts of data available. To build the asset type ontology, we leverage content from third party providers, such as Asset Performance Technologies (APT), which has over 600 assets described in terms of device function, preventative maintenance, failure causes, failure modes, and failure effects.

The PARCS™ score are complemented by further calculations that provide predictions and recommendations. First, there are data specific to assets that can provide further indication of a change in a PARCS™ score. For example, vibrational data can indicate if a motor has a greater chance of failure in the future. Therefore, the PARCS™ framework allows peripheral models to indicate future trends in performance, availability, etc. A recommendation engine will also be built to aid serviceability. By leveraging available data, we can indicate expected costs and time needed to perform corrective maintenance. Optimization algorithms will be used to minimize cost and time and optimize the maintenance of an asset by recommending optimized maintenance plans. The maintenance plans will be dynamically updated based on the data continuously collected from the assets as well as the factory environment.

In FIG. 26, we introduce the high level components of PARCS™, described below.
1. Data Sources
   a. External Content—of device function, preventative maintenance, failure causes, failure modes, and failure effects. These data are in semi-structured format with some fields completely unstructured.
      i. The following provides an overview of the Asset data that is available for use with PARCS™
         1. Asset Library of hundreds of equipment types and failure modes.
         2. Preventative Software Algorithms, such as failure rate analysis.
b. Asset Data:
   i. The core data for PARCS™ (i.e. the minimum required for the calculations) include at least one year of history for each asset from Asset Management and/or Asset Performance systems:
      1. Production—number of units produced per unit time
      2. Maintenance type—the recurring maintenance and corresponding dates
      3. Repair time—the time it takes to perform each maintenance procedure
      4. Failure/Downtime—the downtime of the device and date
      5. Capacity—the maximum production of each asset
   ii. PARCS™ data store: An accumulation of all asset data used to calculate PARCS™ scores will be stored on the distributed file system (part of Machine Learning Services).

### 2. Microservices

a. Asset and Data Discovery Service
   i. Business value: The service determines and ranks the most likely candidates for asset type (see 1a) and asset data (see 1b).
   ii. Input/Output
      1. The input is asset type list, asset data, and a path to structured (column) data that might represent the asset data (see 1b). These asset data will be in flat files or a directory of files (one directory per schema), placed on any local or network drive.
         API calls will initiate processing for each type of data separately. Specifically, the asset data should represent one asset type per request and one data schema per request and each request will correspond to one of the five PARCS™ scores. The APT data will be refreshed only periodically, to update data as needed.
      2. The output is a list of recommendations for asset type and asset data (see 1b) as well as relevant parameters including units, time periods, and scores used to recommend the data fields.
b. Data Aggregation and Cleanup Service
   i. Business value: This service is used to increase the speed and accuracy of the calculations. Primary roles include filtering only necessary data, changing units of data fields, and calculating priors for parameters (i.e. the default value for parameters if there is minimal or no data)
   ii. Input/Output
      1. The input is asset type and asset data (see FIG. 1b).
         API calls will initiate processing for each type of data separately. Specifically, the asset data should represent one asset type per request and one data schema per request and each request will correspond to one of the five PARCS scores. Priors will be updated after every new set of data added to the PARCS™ distributed data store
      2. The output is a set of clean data and parameters necessary for each of the five PARCS™ scores
c. Historical PARCS™ Service
   i. Business value: This service provides a present time and historical set of metrics that can be used to assess assets individually or within a system. For the former, five normalized scores are calculated on a standard scale, analogous to FICO. For the latter, the five PARCS™ scores have units that give business insight. Furthermore, an equation editor will allow subject matter experts to modify the underlying equations and insert their own business logic. Therefore, QiO can learn any sophisticated logic from the customer and integrate that in subsequent iterations.
   ii. Input/Output
      1. The input is a set of cleaned data and parameters for each of the five PARCS™ calculations.
      2. API calls will initiate processing for each type of data separately. Specifically, the asset data should represent one asset type per request and one data schema per request and each request will correspond to one of the five PARCS™ scores.
         a. Asset data request:
         /asset_data/performance/{path_to_data/json}
         b. Equation editor interface might be controlled through a Jupyter notebook or a custom UI. If the later, an API will need to be designed.
      3. The output is a PARCS™ score and corresponding statistics and parameters involved with the calculation
d. Trending PARCS™ Service
   i. Business value: This service is used to expand upon the data sources and calculations of the historical PARCS™ service. The additional calculations and predictions will be used to adjust the PARCS™ scores and suggest the future trend of the scores for each asset.
   ii. Input/Output
      1. The input is each of the five PARCS™ scores and the historic values for more than one year time period. Also, predictive services, if available, will be used to scale and predict the PARCS™ scores.
      2. API calls will initiate processing for each type of data separately. Specifically, the asset data should represent one asset type per request and one data schema per request and each request will correspond to one of the five PARCS™ scores. Predictive services will either scale a historical score or scale a trend.
e. Peripheral Services
   i. Asset and Data Identification UI: This service is used for the user to confirm or change the data tables/columns used for the PARCS™ historical calculations. Also, the user will confirm or select the asset type.
   ii. Learning Workbench/Equation editor: This service allows the user to scale and adjust equations used for the unnormalized PARCS™ score. The user will be able to integrate their own business logic and have transparency into the PARCS™ scores. Furthermore, this interface will allow QiO to learn any sophisticated logic from the customer, which can be integrated into the calculation in subsequent iterations.
   iii. Predictive Services: These services are tools to augment the PARCS™ core historical calculations. In some cases, there will be additional data, which can be structured or unstructured, that provide insights into one or more of the PARCS™ scores. These services will either scale the historical PARCS™ score and/or scale the trending score. For example, predictive maintenance

Asset Value Calculator: This service(s) is used to apply the PARCS™ scores to additional contexts such as risk prediction, insurance/warranty models, and financial planning. These services are outside of the scope of PARCS™, although they are closely connected. The asset value calculators depend on external data sources that provide insight into additional contexts above.

### PARCS™ Architecture for Autonomous Vehicles

FIG. 23 depicts an architecture of a system according to the invention for use with autonomous or other vehicles. This parallels the architecture shown in FIG. 3 and discussed above. With reference to FIG. 23, labeled elements have the same meaning as in FIG. 3, except insofar as the following:
In the embodiment of FIG. 23. a cellular network is assumed to provide communications coupling between NAUTLIAN™ software running in the cloud platform and the Cloud in a Box (represented in the top half of drawing) instantiations on individual vehicles. Use of such a cell network (integration provided by Syniverse) is only by way of example: those skilled in the art will appreciate that in many embodiments, communications between the Cloud in a Box and the main cloud platform will be supported by a plurality of networks.
In the embodiment of FIG. 23, the same version of Vehicle Performance Applications and analytics run on the public or private cloud as run in local Cloud in a Box instances, augmented with data from SAP or other business systems or environmental or social media networks to supplement vehicle maintenance (and autonomous control) information.

### PARCS™ for Financial Services

FIG. 24 illustrates the use of PARCS™ score to assess ‘Risk’ in real time for Assets (industrial, consumer or human) to drive transparency of asset utilization to financial institutions involved in managing risk for insurance:premiums and claims. Mutual funds and investors to assess product, market, social and environmental risk to revenues and liability, and Banks to assess risk and valuations of assets for financing loans and acquisitions.

### Example of Use of System According to Invention

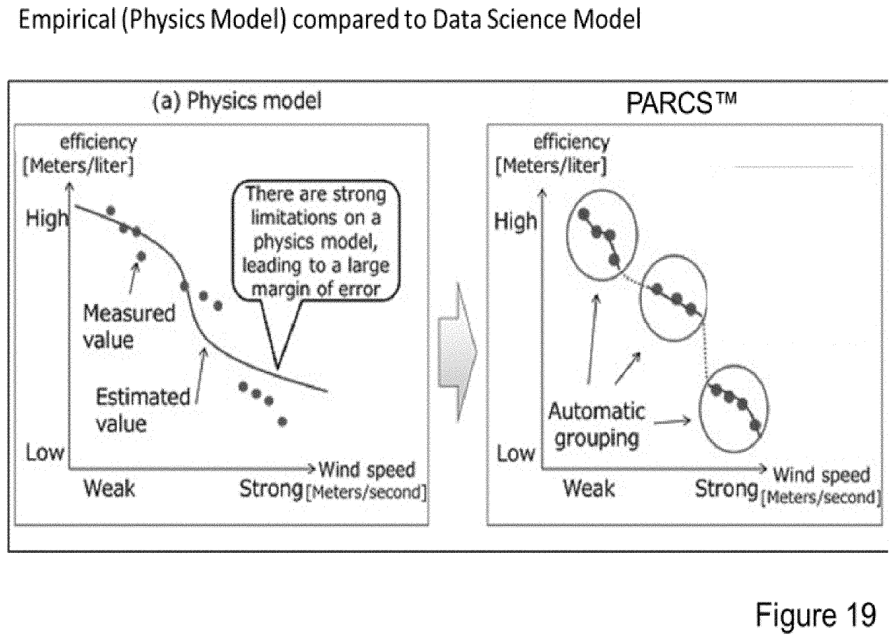

An architecture illustrating the use of Foresight Engine, PARCS™ and the NAUTILIAN™ platform is covered below. FIG. 19 provides an illustration of existing empirical models that are based on physics to represent asset behavior can be improved and enhanced through the use of Cloud, Big Data and Data Science tools to create an predictive efficiency score based on the PARCS™ framework.

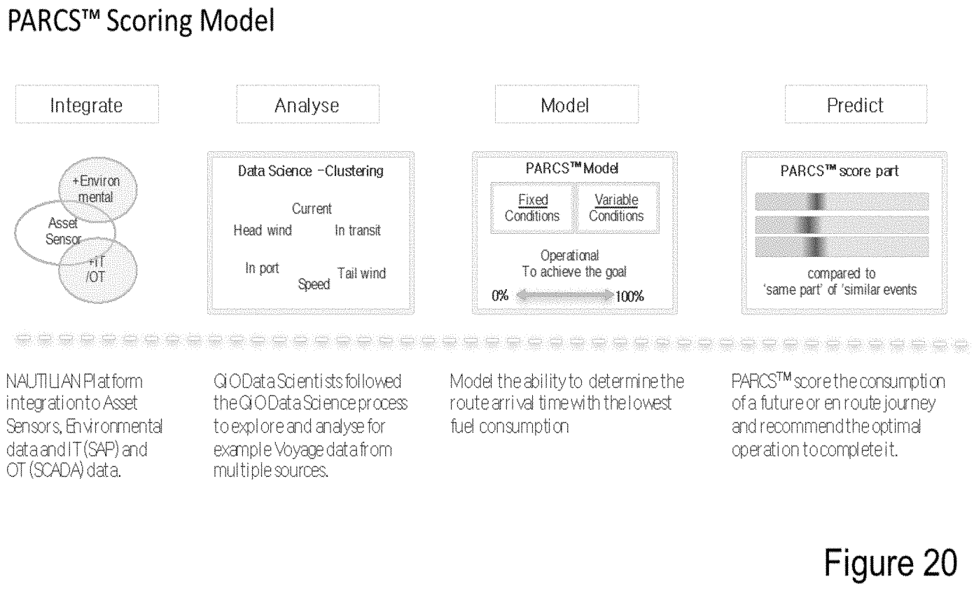

This system, depicted in FIG. 20, is developed using the Foresight Engine notebook to ingest data from Asset sensors, environmental data (wind, weather, tide conditions), location data and then analyzed, a PARCS™ model created and trained and then a predictive efficiency score determined to reflect the Assets behavior over time and a comparison to other similar Assets.

The process adopted is summarized below:

### Data Ingestion

Control variables are defined as all variables that can be adjusted by the operator of an asset. Telematics data for the Asset per minute from sensors on the Asset and by aggregating the time series data over events and time.

Uncontrolled variables are defined as variables, such as environmental data such as outside temperature direction, that cannot be altered by the Operator of the Asset.

### Feature Engineering

Involves the transformation and aggregation of controlled and uncontrolled variables. For example uncontrolled variable such as Wind direction (in degrees) in converted into unit vectors, to reduce data errors in analysis. In addition controlled and uncontrolled variables are aggregated per Asset Event (for example a shutdown or at start-up), using Apache SparkSQL interface and partitioning each unique event. Normalization of events and clustering is via the use of data science algorithms such as KDTree and KMeans. After aggregating the variables scatter plot diagrams are produced to validate results for the aggregation process.

### Development—PARCS™ Model and Score

The PARCS™ engine (as shown in FIGS. 13a and 13b and identified there and elsewhere herein and in the prior documents hereto under the acronym SPARC) is used to test the validation criteria to determine which method would produce the most accurate result and score. As an example the use of KDTree to index millions of multi-dimensional points, the index then supports querying and returns number of points closet in terms of feature space. Clustering uncontrolled variables per Asset Event based on similar conditions to build a PARCS™ scoring index.

A code snippet of the clustering logic as an input into the PARCS™ model is provided below:

PARCS ™ - Example Efficiency Scoring
# read data into distributed data structure
df=da.read_spark_dataframe_from_local_csvfile(SQLCTX,filepath,True,True)
# add engineered features
df=lru.add_externalvariable_1_angle_vectors(df)
df=lru.add_externalvariable_2_vectors(df)
df=lru.add_feature_columns(df)
# aggregate each event into average values
agg_df=aggregate(df)
# define features which describe environmental variables. These are used for clustering
AVG_CONTROL_FEATURES=[
“avg_curr_dir_u”,
“avg_curr_dir_v”,
“avg_current_mag”,
“avg_WSPD”,
“avg_externalvariable_1_x”,
“avg_externalvariable_1_y”,
“length_of_time”,
]
# process the data into min-max scaled features
df=da.convert_doublecols_todensevector(df,AVG_CONTROL_FEATURES,‘features’,False)
df=ft.minmax_scale_dense_vector_column(df,‘features’,‘scaled_features’,False)
# run kmeans algorithm, K=11. This value was derived from analysing results over various values of K
#returns the aggregated dataframe with each event labeled with a cluster label, and the kmeans model
kmeans_transformed_df,kmeans_model=st.run_kmeans(agg_df,‘scaled_features’,11, 11)
#add column with meter event consumption per duration length
kmeans_transformed_df=kmeans_transformed_df.withColumn(“foc_per_nm”,col(‘foc’)/col(‘distanceTravelled’))
#split the dataframe into a list of dataframes, each dataframe contains only members from a single
cluster
dfs=da.split_dataframes_into_list_by_column(k_df,‘kmean_pred’)
#get an example event to test efficiency prediction
event_df=get_example_event_data( )
#label the example event with the cluster it belongs to
example_event_df=kmeans_model.transform(event_df)
relevant_label= example_event_df.select(‘kmean_pred’).collect( )
#get the events observed within the relevant cluster
relevant_cluster=kmeans_transformed_df.filter(kmeans_transformed_df.kmean_pred=relevant_label)
#order by foc per nm, and get the most efficient value in order to generate event efficiency
best_foc_per_nm_for_event=relevant_cluster.orderBy(“foc_per_nm”).select(“foc_per_nm”).head( )
foc_per_nm_for_example_event= example_event_df.select(“foc_per_nm”).head( )
#event efficiency for the test event is then calculated as below
event_efficiency_score=best_foc_per_nm_for_event/foc_per_nm_for_example_event

### Health Care, Financial Services and Other Enterprises

Although the discussion above focuses largely on practices of the invention in connection with enterprise-level plant and industrial monitoring and control (as well as autonomous vehicle operation and maintenance), it will be appreciated that the invention has application, as well, in health care, financial services and other enterprises that benefit from the collection and systemic anticipatory analysis of large data sets. In regard to health care, for example, it will be appreciate that the teachings hereof can be applied to the monitoring, maintenance and control of networked, instrumented (i.e., “sensor-ized”) health care equipment in a hospital or other health-care facility, as well as in the monitoring of care of patients to which that equipment is coupled. In regard to financial services, it will be appreciated that the teachings hereof can be applied to the monitoring, value estimation and PARCS-based expected life predication of networked, instrumented equipment of all sorts (e.g., consumer product, construction, office/commercial, to name a few) in a plant, office building or other facility, thereby, enabling insurers, equity funds and other financial services providers (and consumers) to estimate actual depreciation, current and future value of such assets.

### SUMMARY

Described above are systems and methods meeting the objects set forth previously, among many others. It will be appreciated that the embodiments shown in the drawings and discussed here are merely examples of embodiments of the invention, and that other embodiments incorporating changes to those shown here fall within the scope of the invention. It will be appreciated, further, that the specific selections of hardware and software components discussed herein to construct embodiments of the invention are merely by way of example and that alternates thereto may be utilized in other embodiments.

In view of the foregoing, what we claim is:

1-20. (canceled)

21. A method for improving management of a physical asset, comprising:
creating a digital asset model comprising a plurality of metrics, the digital asset model corresponding to the physical asset that comprises a first component and a second component;
generating, based on the digital asset model, a time-series forecast for the physical asset; and
providing, based on the time-series forecast, information for modification of an operation of the first component or the second component,
wherein the plurality of metrics comprises a performance metric, an availability metric, a reliability metric, a capacity metric, and a serviceability metric, and
wherein creating the digital asset model comprises:
measuring one or more outputs of the first component during an operation of the first component and one or more outputs of the second component during an operation of the second component;
generating, based on the measuring, a first set of time-series data for each of a first set of parameters that characterize the first component and a second set of time-series data for each of a second set of parameters that characterize the second component,
generating, using a machine learning algorithm and based on the first and second sets of time-series data, a plurality of correlations between the first set of parameters and the second set of parameters, and
generating, based on the plurality of correlations, the plurality of metrics.

22. The method of claim 21, further comprising:
generating an overall score for the physical asset by combining the plurality of metrics.

23. The method of claim 21, further comprising:
generating an indication of health and behavior of the physical asset based on each of the plurality of metrics.

24. The method of claim 21, wherein generating the time-series forecast using the digital asset model requires less computational complexity than generating the time-series forecast using a mathematical physics-based model of the physical asset.

25. The method of claim 21, further comprising:
analyzing another similar physical asset based on the plurality of metrics of the physical asset.

26. The method of claim 21, wherein the plurality of correlations comprises a first correlation between a first parameter of the first set of parameters and a second parameter of the first set of parameters and a second correlation between the first parameter and a third parameter of the second set of parameters.

27. The method of claim 21, wherein the machine learning algorithm comprises a clustering algorithm based on a kd-Tree method or a K-means method.

28. The method of claim 21, wherein the machine learning algorithm comprises a neural network with high dimensionality.

29. The method of claim 21, wherein the performance metric is indicative of a balance between an effectiveness and an efficiency of the physical asset, wherein the availability metric is indicative of a potential for using the physical asset for its intended purpose, wherein the reliability metric is indicative of a frequency of outages, availability and usage of the physical asset, wherein a capacity metric is indicative of a capability of the physical asset to provide a desired output per period of time, and wherein the serviceability metric is indicative of one or more features of the physical asset that support an ease, a cost or a speed of maintenance of the physical asset.

30. The method of claim 21, further comprising:
generating, based on the first and second sets of time-series data, diagnostic information for detecting errors associated with the physical asset.

31. The method of claim 30, wherein generating the diagnostic information is performed on a local computing platform, and wherein generating the plurality of correlations is performed on a remote computing platform.

32. The method of claim 21, further comprising:
generating, on a local computing platform, a first set of insights and outcomes associated with the physical asset based on downsampling the first and second sets of time-series data to a first time interval; and
generating, on a remote computing platform, a second set of insights and outcomes associated with the physical asset based on downsampling the first and second sets of time-series data to a second time interval.

33. A system for improving management of a physical asset, comprising:
a processor and a memory including instructions stored thereupon, wherein the instructions upon execution by the processor cause the processor to:
create a digital asset model comprising a plurality of metrics, the digital asset model corresponding to the physical asset that comprises a first component and a second component;
generate, based on the digital asset model, a time-series forecast for the physical asset; and
provide, based on the time-series forecast, information for modification of an operation of the first component or the second component,
wherein the plurality of metrics comprises a performance metric, an availability metric, a reliability metric, a capacity metric, and a serviceability metric, and
wherein the processor is further configured, as part of creating the digital asset model, to:
measure one or more outputs of the first component during an operation of the first component and one or more outputs of the second component during an operation of the second component;
generate, based on the measuring, a first set of time-series data for each of a first set of parameters that characterize the first component and a second set of time-series data for each of a second set of parameters that characterize the second component,
generate, using a machine learning algorithm and based on the first and second sets of time-series data, a plurality of correlations between the first set of parameters and the second set of parameters, and
generate, based on the plurality of correlations, the plurality of metrics.

34. The system of claim 33, wherein the processor is further configured to:
generate an overall score for the physical asset by combining the plurality of metrics.

35. The system of claim 33, wherein generating the time-series forecast using the digital asset model requires less computational complexity than generating the time-series forecast using a mathematical physics-based model of the physical asset.

36. The system of claim 33, wherein the machine learning algorithm comprises at least one of a clustering algorithm based on a kd-Tree method or a K-means method or a neural network with high dimensionality.

37. The system of claim 33, wherein the performance metric is indicative of a balance between an effectiveness and an efficiency of the physical asset, wherein the availability metric is indicative of a potential for using the physical asset for its intended purpose, wherein the reliability metric is indicative of a frequency of outages, availability and usage of the physical asset, wherein a capacity metric is indicative of a capability of the physical asset to provide a desired output per period of time, and wherein the serviceability metric is indicative of one or more features of the physical asset that support an ease, a cost or a speed of maintenance of the physical asset.

38. A non-transitory computer-readable storage medium having instructions stored thereupon for improving convergence of a soft bit-flipping decoder in a non-volatile memory device, comprising:
instructions for creating a digital asset model comprising a plurality of metrics, the digital asset model corresponding to the physical asset that comprises a first component and a second component;
instructions for generating, based on the digital asset model, a time-series forecast for the physical asset; and
instructions for providing, based on the time-series forecast, information for modification of an operation of the first component or the second component,
wherein the plurality of metrics comprises a performance metric, an availability metric, a reliability metric, a capacity metric, and a serviceability metric, and
wherein the instructions for creating the digital asset model comprise:
instructions for measuring one or more outputs of the first component during an operation of the first component and one or more outputs of the second component during an operation of the second component;
instructions for generating, based on the measuring, a first set of time-series data for each of a first set of parameters that characterize the first component and a second set of time-series data for each of a second set of parameters that characterize the second component,
instructions for generating, using a machine learning algorithm and based on the first and second sets of time-series data, a plurality of correlations between the first set of parameters and the second set of parameters, and
instructions for generating, based on the plurality of correlations, the plurality of metrics.

39. The computer-readable storage medium of claim 38, further comprising:
instructions for generating an indication of health and behavior of the physical asset based on each of the plurality of metrics.

40. The computer-readable storage medium of claim 38, wherein the performance metric is indicative of a balance between an effectiveness and an efficiency of the physical asset, wherein the availability metric is indicative of a potential for using the physical asset for its intended purpose, wherein the reliability metric is indicative of a frequency of outages, availability and usage of the physical asset, wherein a capacity metric is indicative of a capability of the physical asset to provide a desired output per period of time, and wherein the serviceability metric is indicative of one or more features of the physical asset that support an ease, a cost or a speed of maintenance of the physical asset.
